(19) United States
(12) Patent Application Publication
(10) Pub. No.: US 2013/0236766 A1
(43) Pub. Date: Sep. 12, 2013

(54) HEAT-RESISTANT SEPARATOR, ELECTRODE ASSEMBLY AND SECONDARY BATTERY USING THE SAME, AND METHOD FOR MANUFACTURING SECONDARY BATTERY

(71) Applicant: AMOGREENTECH CO., LTD., Gimpo-si (KR)

(72) Inventors: In Yong SEO, Seoul (KR); Yong Sik JUNG, Namyangju-si (KR)

(73) Assignee: AMOGREENTECH CO., LTD., Gimpo-si (KR)

(21) Appl. No.: 13/869,322

(22) Filed: Apr. 24, 2013

Related U.S. Application Data
(63) Continuation of application No. PCT/KR2011/008242, filed on Nov. 1, 2011.

(30) Foreign Application Priority Data
Nov. 1, 2010 (KR) 10-2010-0107643

(51) Int. Cl. H01M 2/16

(52) U.S. Cl. CPC H01M 2/1653
USPC 429/144; 427/77; 427/458

(57) ABSTRACT

A porous polymer web layer of ultrafine fibers, and a non-porous film layer made of a material that is swellable and allows conduction of electrolyte ions in an electrolyte solution, are integrally provided on one surface or both surfaces of a positive electrode or a negative electrode, and a short circuit between the positive electrode and the negative electrode by the inorganic particles contained in polymer web is prevented although a battery is overheated. The electrode assembly includes: a positive electrode; a negative electrode; and a separator that separates the positive electrode and the negative electrode. The separator comprises: a first non-porous polymer film layer; and a porous polymer web layer that is formed on the first non-porous polymer film layer and is made of ultrafine fibers of a mixture of a heat-resistant polymer and inorganic particles or a mixture of a heat-resistant polymer, a swellable polymer, and inorganic particles.

### TECHNICAL FIELD

The present invention relates to a heat-resistant separator, an electrode assembly, a secondary battery using the electrode assembly, and a method of manufacturing the secondary battery. More particularly, the present invention relates to a heat-resistant separator, an electrode assembly, a secondary battery using the electrode assembly, and a method of manufacturing the secondary battery, in which a short circuit between a positive electrode and a negative electrode is prevented by inorganic particles contained in a polymer web, to thereby promote improvement of stability, even if the battery is overheated.

### BACKGROUND ART

Lithium secondary batteries generate electrical energy by oxidation and reduction reactions that are caused when lithium ions are intercalated/deintercalated. Lithium secondary batteries are manufactured by using substances which are capable of reversibly intercalating/deintercalating lithium ions as active materials of a positive electrode and a negative electrode, respectively, and filling an organic electrolyte or a polymer electrolyte between the positive electrode and the negative electrode.

Lithium secondary batteries are configured to have an electrode assembly in which a negative electrode plate and a positive electrode plate are wound in a certain form or stacked with a separator interposed between the negative electrode plate and the positive electrode plate, and a case accommodating the electrode assembly and an electrolyte.

A basic function of a separator for lithium secondary batteries separates a positive electrode and a negative electrode, to thus prevent a short circuit from occurring. Moreover, it is important to inhale an electrolyte needed for a cell reaction to thus maintain a high ionic conductivity. In particular, the lithium secondary batteries require additional functions in order to prevent movement of substances that inhibits a cell reaction, or ensure safety when an abnormal condition occurs.

Secondary batteries including lithium-ion secondary batteries and lithium-ion polymer batteries of high energy density and large capacity have a relatively high operating temperature range, respectively. In addition, when second batteries continue to be used at a high-rate charge-discharge state, the temperature rises. Thus, separators that are usually used in these secondary batteries require higher heat-resistance and higher thermal stability than those required in ordinary separators. In addition, secondary batteries should have excellent cell characteristics such as high ionic conductivity to respond to rapid charge and discharge and low temperature.

The separator is placed between the positive electrode and the negative electrode of a battery cell to thus perform an isolation function therebetween. The separator maintains an electrolyte solution to thus provide an ionic conduction pathway. The separator has a shutdown function of blocking the pores by melting part of the separator to block electric current if the battery temperature rises up too much.

When the separator is melted as the temperature gets higher, a big hole is created to thus cause a short circuit to occur between the positive electrode and the negative electrode. The temperature is called a short circuit temperature. Generally, the separator should have a higher short circuit temperature than a lower shutdown temperature. In the case of a polyethylene separator, the separator is contracted at 150° C. or higher when a battery cell is abnormally heated, and thus the electrode portion is exposed, to finally cause a short circuit. Therefore, it is very important for the secondary battery to have both a shutdown function and a heat-resistance performance in order to achieve a high-energy density and large-area secondary battery. In other words, it is required that the separator should have an excellent heat-resistance performance to thus cause small thermal shrinkage, and an excellent cycling performance due to a high ionic conductivity.

A fine porous polymer separator or a multi-separator using these fine porous polymer separators usually made of a polyolefin group polymer such as polypropylene and polyethylene is used as a separator material. Since the existing separator has a porous membrane layer in the form of a sheet or film shape, it has the drawbacks such as pore blockage of a porous membrane and shrinkage of a sheet-shaped separator due to an internal short circuit or overcharge. Therefore, if a sheet-shaped separator is shrunken and contracted by the internal heat of a battery, the positive electrode and the negative electrode are placed in direct contact with each other at a portion where the separator has been contracted and then disappeared, to thereby lead to ignition, rupture, and explosion.

In order to ensure adequate safety for the high-energy density and large-area secondary battery, Japanese laid-open patent publication No. 2005-209570 proposed that a polyolefin separator is dipped in a heat-resistant resin. However, dipping of the heat-resistant resin blocks the pores of the polyolefin separator to accordingly restrict movement of lithium ions. As a result, since the charge-discharge characteristics are degraded, the heat-resistant resin dipped polyolefin separator has not met requirements of large-capacity batteries for automobiles, although it has secured the heat-resistance. In addition, although the pores of the polyolefin porous membrane separator are not blocked due to dipping of the heat-resistant resin, the ionic conductivity for the large-capacity battery is limited since porosity of the widely used polyolefin separator is 40% or so and the pore size is also several tens nanometers (nm) in diameter.

In addition, the film type separator produces lithium dendrites entirely at the time of overcharging. This is because a loose space is formed between the negative electrode and the film type separator and lithium-ions that do not go inside the negative electrode are deposited in the negative electrode surface, that is, in the loose space between the negative electrode and the film type separator, to then be precipitated in a lithium metal phase. If lithium is entirely precipitated, the precipitated lithium dendrites pierce the film type separator to thus cause the positive electrode and the negative electrode to contact each other. Simultaneously, side reactions of the electrolyte with lithium metal proceed. Accordingly, the battery may be ignited to explode due to generation of heat and gas according to the reactions.

Moreover, the film type separator is a polyolefin-based film type separator and may cause a hard short circuit since a peripheral film type separator is continuously shrunken or melted in addition to a damaged portion by an initial heat generation when an internal short circuit has occurred, to thus cause a burnt and lost portion of the film type separator to become wider. In other words, in the case that a battery temperature suddenly rises by any reasons such as an external thermoelectric phenomenon, the temperature rise of the battery continues for a certain amount of time although fine pores of the separator are blocked, to thereby cause breakage of the separator.

In addition, when a high capacity of a battery is achieved by a layer of a high-density active material, and thus the densities of electrode plates increase, an electrolytic fluid does not impermeable into the electrode plates. As a result, an injection speed of the electrolyte solution for the battery becomes slow, or an amount of the required electrolyte solution is not injected into the battery.

In addition, if a lot of current flows in a short period of time in a secondary battery, in accordance with the high capacity of the battery, the temperature rise of the battery does not become low by blocking of the current, but the separator rather continues melting by the already generated heat, although fine pores of the separator are blocked, to thereby cause an internal short circuit to occur due to breakage of the separator.

Therefore, as it is required that the internal short circuit between the electrodes should be stably prevented even at high temperatures, a separator made of porous ceramic layers that are formed of particles of a ceramic filler combined with a heat-resistant binder has been proposed.

Since the ceramic layers are highly safe for the internal short circuit, and are coated and adhered on the electrode plates, there is no problem that the ceramic layers are shrunken or melted when an internal short circuit occurs. In addition, since the ceramic powder of a high porosity is used, the ceramic layers have good high-rate charge and discharge characteristics, and since the ceramic layers absorb the electrolyte solution quickly, an injection speed of the electrolyte solution is improved.

The ceramic layers are formed all over an electrode current collector and an electrode active material layer on at least one surface of two facing surfaces between a positive electrode plate and a negative electrode plate. Therefore, since the conventional ceramic layers are deposited all over the surfaces other than plain portions such as a start end and a finish end where the active material layer is not formed on the positive electrode plate and the negative electrode plate, it is difficult to secure a uniform thickness, to thereby make it difficult to perform a quality control and also cause production efficiency to decrease due to an increased material cost.

In addition, each of the ceramic layers typically is formed of a homogeneous ceramic filler to thus be formed into a single layer. If the ceramic layer is a single layer made of only finer tiny particles, it is too dense to promote the smooth movement of lithium ions. Therefore, the high-rate charge and discharge capacity or low-temperature charge-discharge capacity becomes smaller. In this case, if an identical amount of a binder is used, the smaller the particles may be in size, the wider the surface area may be. As a result, an absolute amount of the binder lacks and thus flexibility is also deteriorated.

Moreover, lithium secondary batteries having porous ceramic layers made of a ceramic material and a binder (that is, ceramic separators) require a very high processing precision rate in order to form the porous ceramic layers without causing secession of ceramic materials a uniform and constant thickness all over the entire area when the porous ceramic layers are formed into thin films of 1-40 μm by casting ceramic slurry onto the active materials in the negative electrode or the positive electrode, and cause cracks to occur when a battery is assembled by stacking the negative electrode and positive electrode.

Meanwhile, PCT international patent publication No. WO2001/89022 relates to a lithium secondary battery including an ultrafine fibrous porous polymer separator and a manufacturing method thereof, and disclosed a technology of manufacturing the lithium secondary battery by using a method including the steps of: melting one or more polymers by a porous polymer separator, or dissolving one or more polymers in an organic solvent, to thus obtain a melted polymer or polymer solution; inputting the melted polymer or polymer solution into a barrel of a charge induced electrospinning machine; and charge-induced-electrospinning the melted polymer or polymer solution through nozzles on a substrate, to thereby form the porous polymer separator.

In addition, the porous polymer separator is obtained by electrospinning a polymer solution that is formed by dissolving one or more polymers in an organic solvent to then be manufactured into 50 μm thick, and then inserting the porous polymer separator between the negative electrode and positive electrode in order to manufacture a lithium secondary battery to thus achieve integration by stacking.

In addition, the Korean laid-open patent publication No. 2008-13208 disclosed a heat-resistant ultrafine fibrous separator and a manufacturing method thereof, and a secondary battery using the same. Here, the heat-resistant ultrafine fibrous separator is manufactured by an electrospinning method, and is made of an ultrafine fiber of a heat-resistant polymer resin having the melting point of 180° C. or higher or having no melting point, or made of an ultrafine fiber of a polymer resin that can be swollen in an electrolyte solution together with the ultrafine fiber of the heat-resistant polymer resin.

In addition, the Korean laid-open patent publication No. 2008-13208 proposed that the separator should contain 1-95 wt % of inorganic additives such as TiO₂ to improve the mechanical properties, ionic conductivity, and electrochemical characteristics.

However, in the case that a large amount of the inorganic additives are contained in a spinning solution, dispersion is lowered to thus make it difficult to perform a spinning operation. Also, in the case that the inorganic additives are spun together with the polymer material, they rather act as impurities in the spun fibers to thus cause dropping of strength.

Conventional polyolefin-based film type separators proposed in Japanese laid-open patent publication No. 2005-209570, and Korean laid-open patent publication No. 2004-108525, or conventional film type separators made of nano-fiber webs proposed in Korean laid-open patent publication No. 2008-13208, are manufactured in a state of being separated from electrodes and then being inserted between the positive electrode and the negative electrode, to thereby cause productivity of an assembly to be low.

In other words, when the film type separator is inserted and then assembled between the positive electrode and the negative electrode, a high alignment precision is required during assembly, and the manufacturing process is troublesome, and when the film type separator is shocked, the electrodes are pushed out to thus cause a short circuit to occur.

In particular, to configure high-capacity batteries for electric vehicles, a multiplicity of unit cells are stacked in a multilayer form, a stack-folding type structure of folding a bicell or full cell by using a long length of a continuous separate film is employed to thereby cause an assembly process to be complex and wetting to be lowered at the time of impregnating the electrolyte.

Moreover, an electrode assembly process of using a conventional film type separator is complicated. Wetting is not only lowered at the time of impregnating the electrolyte, but also the adhesion power of the separator and electrodes acts as an important variable. As a result, a complex process of coating a polymer material on the separator is needed.

Meanwhile, in order to solve a low wetting phenomenon of the stack type electrode assembly and an electrode pushing phenomenon due to shock of electrodes, Korean laid-open patent publication No. 2007-114412 proposed a technology of forming a number of perforated holes that make the electrolyte facilitate to enter into and exit from a corresponding portion of the separate film wrapping around the side of the electrode assembly.

In addition, in the case of these stack type or stack-folding type electrode assembly, adhesion power force between each of the electrodes and the separator is low, and thus interfacial resistance between each of the electrodes and the separator is high, and lithium dendrite is precipitated in a loose space between the negative electrode and the film type separator.

### BRIEF SUMMARY OF THE INVENTION

To solve the above problems or defects of the conventional art, it is an object of the present invention to provide a separator including a porous polymer web layer of ultrafine fibers made of a mixture of a heat-resistant polymer and inorganic particles or a mixture of a heat-resistant polymer, a swellable polymer, and inorganic particles, and a non-porous film layer made of a material that is swellable in an electrolyte solution and allows conduction of electrolyte ions, in which the separator is integrally provided on one surface or both surfaces of a positive electrode or a negative electrode, using an electrospinning method, and an electrode assembly that can prevent a short circuit between the positive electrode and the negative electrode by the inorganic particles contained in a polymer web although a battery is overheated to thus promote improvement of a stability of the battery, and to provide a secondary battery using the same, and a method of manufacturing the same.

It is another object of the present invention to provide an electrode assembly and a secondary battery using the same, in which a non-porous film layer made of a material that is swellable in an electrolyte solution and allows conduction of electrolyte ions is directly electrospun on a surface of a negative electrode to then be formed close to the surface of the negative electrode, to thereby inhibit formation of dendrites and to thus promote improvement of a stability of a battery.

It is still another object of the present invention to provide an electrode assembly and a secondary battery using the same, in which a polymer web layer of heat-resistant ultrafine fibers containing inorganic matters and a non-porous film layer made of a material that is swellable in an electrolyte solution and allows conduction of electrolyte ions, are sequentially electrospun on a positive electrode or a negative electrode to thus form a stacked separator, to thereby maintain a low interfacial resistance between the electrode and the separator and prevent a micro short-circuit due to secession of a fine active material.

It is yet another object of the present invention to provide an electrode assembly and a secondary battery using the same, in which a stacked separator of a multilayer structure of a polymer web layer and a non-porous film layer is sequentially formed on a positive electrode or a negative electrode by using an electrospinning method, to thereby make it easy to manufacture the separator, and quickly accomplish impregnation of an electrolyte solution in the polymer web layer, and to thus shorten a manufacturing process time.

It is yet still another object of the present invention to provide an electrode assembly and a secondary battery using the same, in which a separator of a multilayer structure is stacked and formed on a positive electrode or a negative electrode by using an electrospinning method, when large-capacity batteries for electric vehicles are manufactured in a large-size form and in a stack type, to thus assemble the electrode assembly by simply stacking the positive electrode or the negative electrode that is integrally formed with the separator, and to accordingly provide excellent assembly performance and mass-productivity.

It is a further object of the present invention to provide a heat-resistant separator of a multilayer structure including a polymer web layer of heat-resistant ultrafine fibers containing inorganic matters and a non-porous film layer made of a material that is swellable in an electrolyte solution and allows conduction of electrolyte ions, and a method of manufacturing the same.

To accomplish the above and other objects of the present invention, according to an aspect of the present invention, there is provided an electrode assembly comprising:

a positive electrode;

a negative electrode; and

a separator that separates the positive electrode and the negative electrode,

wherein the separator comprises:

a first non-porous polymer film layer; and

a porous polymer web layer that is formed on the first non-porous polymer film layer and is made of ultrafine fibers of a mixture of a heat-resistant polymer and inorganic particles or a mixture of a heat-resistant polymer, a swellable polymer, and inorganic particles.

Preferably but not necessarily, the electrode assembly further comprises a second non-porous polymer film layer that is formed to cover the negative electrode.

Preferably but not necessarily, the separator is formed on one or both surfaces of the positive electrode or the negative electrode.

Preferably but not necessarily, the first and second non-porous polymer film layers are made of a polymer that is swellable in an electrolyte solution and allows conduction of electrolyte ions.

Preferably but not necessarily, the polymer that is swellable in an electrolyte solution and allows conduction of electrolyte ions is any one of PVDF (PolyVinyliDene Fluoride), PEO (PolyEthylene Oxide), PMMA (PolyMethlMethAcrylate), and TPU (Thermoplastic PolyUrethane).

Preferably but not necessarily, a content of the inorganic particles is in a range of 10 to 25 wt % for the whole mixture, and a size of the inorganic particles is set in a range of 10 and 100 nm, preferably in a range of 15 and 25 nm.

Preferably but not necessarily, a thickness of each of the first and second non-porous polymer film layers is set in a range of 5 to 14 μm, and a thickness of the porous polymer web layer is set in a range of 5 to 50 μm, preferably in a range of 10 to 25 μm.

Preferably but not necessarily, the inorganic particles comprise at least one selected from the group consisting of TiO₂, BaTiO₃, Li₂O, LiF, LiOH, Li₃N, BaO, Na₂O, Li₂CO₃, CaCO₃, LiAlO₂, SiO₂, Al₂O₃, S10, SnO, SnO₂, PbO₂, ZnO, P₂O₅, CuO, MoO, V₂O₅, B₂O₃, Si₃N₄, CeO₂, Mn₃O₄, Sn₂P₂O₇, Sn₂B₂O₅, and Sn₂BPO₆, and a mixture thereof.

Preferably but not necessarily, the heat-resistant polymer and the swellable polymer are mixed at a weight ratio in a range of 5:5 to 7:3, in the case of the mixture of the heat-resistant polymer, the swellable polymer, and the inorganic particles.

Preferably but not necessarily, the electrode assembly is formed by stacking a number of the positive electrodes surrounded in a sealed state by the separator and a number of the negative electrodes that are respectively inserted between the number of the positive electrodes, to thus easily configure a large-capacity battery.

According to a second aspect of the present invention, there is provided an electrode assembly comprising:

a positive electrode having a positive electrode active material layer formed on at least one surface of a positive electrode current collector;

a first non-porous polymer film layer that is formed to cover the positive electrode active material layer;

a porous polymer web layer that is formed on the first non-porous polymer film layer and is made of ultrafine fibers of a mixture of a heat-resistant polymer and inorganic particles or a mixture of a heat-resistant polymer, a swellable polymer, and inorganic particles; and

a negative electrode that is disposed to face the positive electrode and includes a negative electrode active material layer formed on at least one surface of a negative electrode current collector.

Preferably but not necessarily, the first non-porous polymer film layer is made of a polymer that is swellable in an electrolyte solution and allows conduction of electrolyte ions.

According to a third aspect of the present invention, there is provided a secondary battery comprising:

a positive electrode;

a negative electrode;

a separator that separates the positive electrode and the negative electrode; and

an electrolyte solution,

wherein the separator comprises:

a first non-porous polymer film layer that is swellable in the electrolyte solution and that allows conduction of electrolyte ions; and

a porous polymer web layer that is formed on the first non-porous polymer film layer and is made of ultrafine fibers of a mixture of a heat-resistant polymer and inorganic particles or a mixture of a heat-resistant polymer, a swellable polymer, and inorganic particles.

According to a fourth aspect of the present invention, there is provided a method of manufacturing an electrode assembly, the method comprising the steps of:

preparing a positive electrode having a positive electrode active material layer formed on at least one surface of a positive electrode current collector, and a negative electrode having a negative electrode active material layer formed on at least one surface of a negative electrode current collector, respectively;

forming a separator a porous polymer web layer and a first non-porous polymer film layer, to cover one of the positive electrode and the negative electrode; and

opposing and crimping to assemble the positive electrode and the negative electrode.

Preferably but not necessarily, the forming of the first non-porous polymer film layer comprises:

dissolving a polymer that is swellable in an electrolyte solution and allows conduction of electrolyte ions, in a solvent, to thus form a spinning solution;

electrospinning the spinning solution on the positive electrode active material layer or the negative electrode active material layer, to thus form an ultrafine fibrous porous polymer web; and

heat-treating or calendering the porous polymer web to then be transformed into a non-porous film layer.

Preferably but not necessarily, the forming of the porous polymer web layer comprises:

dissolving a mixture of a heat-resistant polymer and inorganic particles or a mixture of a heat-resistant polymer, a swellable polymer, and inorganic particles, in a solvent, to thus form a spinning solution;

electrospinning the spinning solution to form an ultrafine fibrous porous polymer web; and

calendering the porous polymer web.

Preferably but not necessarily, a content of the inorganic particles is in a range of 10 to 25 wt % for the whole mixture, and a size of the inorganic particles is set in a range of 10 and 100 nm.

Preferably but not necessarily, the integral forming of the separator comprises:

dissolving a mixture of a heat-resistant polymer and inorganic particles or a mixture of a heat-resistant polymer, a swellable polymer, and inorganic particles, in a solvent, to thus form a first spinning solution;

dissolving a polymer that is swellable in an electrolyte solution and that allows conduction of electrolyte ions, in a solvent, to thus form a second spinning solution;

electrospinning the first and second spinning solutions on the positive electrode active material layer or the negative electrode active material layer, to thus form first and second ultrafine fibrous porous polymer web layers that are stacked in two layers;

heat-treating the second porous polymer web layer to thus be transformed into the first non-porous polymer film layer; and

calandering the first porous polymer web layer and the first non-porous polymer film layer that have been stacked over each other.

According to a fifth aspect of the present invention, there is provided a method of manufacturing a secondary battery, the method comprises the steps of:

preparing a positive electrode having a positive electrode active material layer formed on at least one surface of a positive electrode current collector, and a negative electrode having a negative electrode active material layer formed on at least one surface of a negative electrode current collector, respectively;

electrospinning a mixture of a heat-resistant polymer and inorganic particles or a mixture of a heat-resistant polymer, a swellable polymer, and inorganic particles, to cover the positive electrode active material layer, to thus form a first porous polymer web layer that is made of ultrafine fibers;

electrospinning the swellable polymer on the first porous polymer web layer, to thus form a second porous polymer web layer that is made of ultrafine fibers, and then heat-treating the second porous polymer web layer to thus be transformed into the first non-porous polymer film layer; and

opposing and crimping to assemble the positive electrode and the negative electrode, to then be put into a case and impregnated into an electrolyte solution.

According to another aspect of the present invention, there is provided a heat-resistant separator that is separated from electrodes, the separator comprising:

a non-porous polymer film layer that is made of a polymer that is swellable in an electrolyte solution and allows conduction of electrolyte ions; and

a porous polymer web layer that is formed on the non-porous polymer film layer and is made of ultrafine fibers of a mixture of a heat-resistant polymer and inorganic particles or a mixture of a heat-resistant polymer, a swellable polymer, and inorganic particles.

According to another aspect of the present invention, there is provided a method of manufacturing a separator, the method comprising the steps of:

dissolving a mixture of a heat-resistant polymer and inorganic particles or a mixture of a heat-resistant polymer, a swellable polymer, and inorganic particles, in a solvent, to thus form a first spinning solution;

dissolving a polymer that is swellable in an electrolyte solution and that allows conduction of electrolyte ions, in a solvent, to thus form a second spinning solution;

electrospinning the first and second spinning solutions, to thus form first and second ultrafine fibrous porous polymer web layers that are stacked in two layers;

heat-treating the second porous polymer web layer to thus be transformed into a non-porous polymer film layer; and

calandering the first porous polymer web layer and the non-porous polymer film layer that have been stacked over each other.

As described above, according to the present invention, a porous polymer web layer of ultrafine fibers made of a mixture of a heat-resistant polymer and inorganic particles or a mixture of a heat-resistant polymer, a swellable polymer, and inorganic particles, and a non-porous film layer made of a material that is swellable in an electrolyte solution and allows conduction of electrolyte ions, are integrally provided on one surface or both surfaces of a positive electrode or a negative electrode, using an electrospinning method, to thus prevent a short circuit between the positive electrode and the negative electrode by the inorganic particles contained in the polymer web layer although a battery is overheated to thus promote improvement of a stability of the battery.

In addition, according to the present invention, a non-porous polymer film made of a material that is swellable in an electrolyte solution and allows conduction of electrolyte ions is directly electrospun on a surface of a negative electrode to then be formed close to the surface of the negative electrode, to thereby maintain conduction of lithium ions and also remove formation of a space between the negative electrode and the film, and to thus prevent the lithium ions from being accumulated and precipitated into a lithium metal, to thus inhibit formation of dendrites, and to thus promote improvement of a stability of a battery.

Moreover, according to the present invention, a polymer web layer of heat-resistant ultrafine fibers containing inorganic matters and a non-porous film layer made of a material that is swellable in an electrolyte solution and allows conduction of electrolyte ions, are sequentially electrospun on a positive electrode or a negative electrode to thus form a stacked separator, to thereby maintain a low interfacial resistance between the electrode and the separator and prevent a micro short circuit due to secession of an active material.

Moreover, according to the present invention, a stacked separator of a multilayer structure of a polymer web layer and a non-porous film layer is sequentially formed on a positive electrode or a negative electrode by using an electrospinning method, to thereby make it easy to manufacture the separator, and quickly accomplish impregnation of an electrolyte solution in the polymer web layer, and to thus shorten a manufacturing process time.

Moreover, according to the present invention, a separator of a multilayer structure is stacked and formed on a positive electrode or a negative electrode by using an electrospinning method, when large-capacity batteries for electric vehicles are manufactured in a large-size form and in a stack type, to thus assemble the electrode assembly by simply stacking the positive electrode or the negative electrode that is integrally formed with the separator, and to accordingly provide excellent assembly performance and mass-productivity.

Moreover, according to the present invention, medium-size and large-size batteries for vehicles that specially require safety and output power characteristics have low thermal shrinkage, heat-resistance, excellent mechanical strength, high safety, excellent cycle characteristics, high energy density, and high capacitance.

### BRIEF DESCRIPTION OF THE DRAWINGS

FIG. 1 is a disassembled cross-sectional view of an electrode assembly according to a first embodiment of the present invention.

FIG. 2 is a cross-sectional view of a positive electrode assembly according to a second embodiment of the present invention.

FIG. 3 is a cross-sectional view of a negative electrode assembly according to a third embodiment of the present invention.

FIG. 4 is a flowchart view explaining a method of manufacturing a secondary battery according to the present invention.

FIGS. 5 to 7 are a plan view of a positive electrode assembly according to a fourth embodiment of the present invention, a cross-sectional view taken along line X-X of FIG. 5, and a cross-sectional view taken along line Y-Y of FIG. 5, respectively.

FIG. 8 is a cross-sectional view of a negative electrode assembly according to the fourth embodiment of the present invention, in a lengthy direction.

FIG. 9 is a graph illustrating charge and discharge characteristics of a secondary battery that employs a separator of Example 1 according to the embodiment of the present invention.

FIG. 10 shows a SEM (Scanning Electron Microscope) picture of a separator of Example 1 according to the embodiment of the present invention.

FIGS. 11 and 12 are graphs respectively illustrating charge and discharge characteristics of secondary batteries that respectively employ separators of Comparative Example 2 and Comparative Example 3.

FIG. 13 shows a SEM picture of a separator of Comparative Example 1.

FIGS. 14 and 15 are graphs respectively illustrating discharge capacity characteristics according to 1C-rate and 2C-rate of secondary batteries that respectively employ separators of Example 3 and Example 4.

FIGS. 16 and 17 show SEM pictures of separators of Comparative Example 7 and Comparative Example 8, respectively, and photos to compare and identify contraction shrinkage after having undergone a heat-resistant test at room temperature, 240° C., and 500° C.

FIG. 18 shows a SEM picture of a separator of Example 6, and photos to compare and identify contraction shrinkage after having undergone a heat-resistant test at room temperature, 240° C., and 500° C.

FIG. 19 shows SEM pictures of separators of Examples 6 to 8, Comparative Example 7 and Comparative Examples 9 and 10, in which contents of inorganic matters are changed, respectively, and photos to compare and identify contraction shrinkage after having undergone a heat-resistant test at room temperature, 240° C., and 500° C.

FIG. 20 is a graph illustrating results of a hot tip test between the room temperature and 450° C. for separators of Example 6, Comparative Example 5 and 6, according to the present invention.

FIG. 21 shows a picture showing a plane surface of a positive electrode on both surfaces of which a separator is coated in a sealed state, and a cross-sectional view for explaining a stacking method thereof.

FIG. 22 is a graph comparatively showing impregnation areas and absorption speed of an electrolyte solution at the time of impregnation of the electrolyte solution, for separators of Example 2, Example 6, Comparative Example 5 and 6, according to the present invention.

### DETAILED DESCRIPTION OF THE INVENTION

Hereinbelow, an electrode assembly and a secondary battery using the same, in accordance with respective embodiment of the present invention will be described with reference to the accompanying drawings.

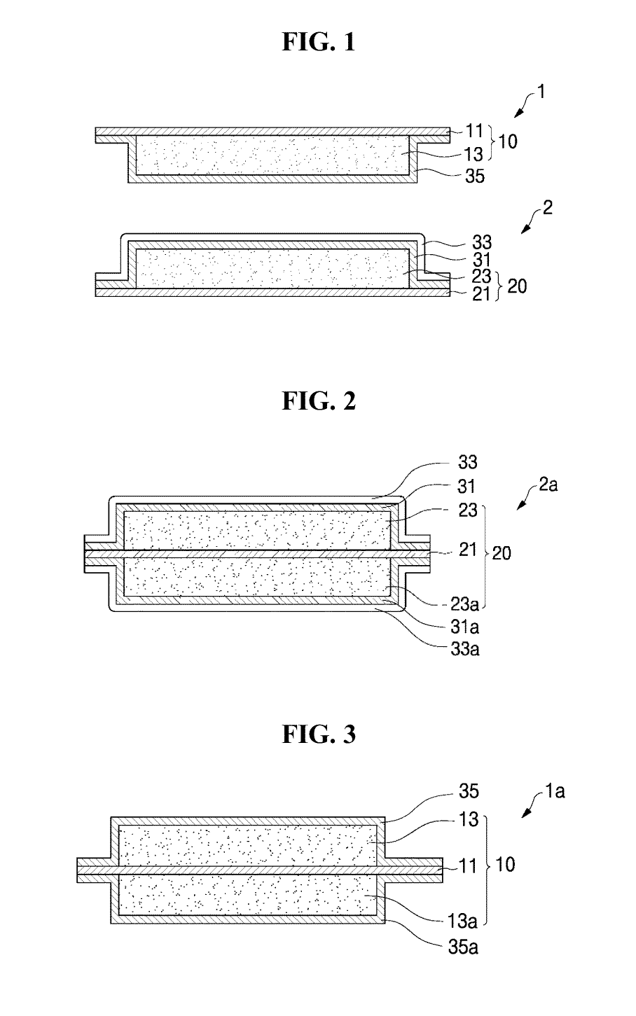

FIG. 1 is a disassembled cross-sectional view of an electrode assembly according to a first embodiment of the present invention. FIG. 2 is a cross-sectional view of a positive electrode assembly according to a second embodiment of the present invention. FIG. 3 is a cross-sectional view of a negative electrode assembly according to a third embodiment of the present invention.

First, referring to FIG. 1, an electrode assembly according to a first embodiment of the present invention, includes a negative electrode assembly 1 and a positive electrode assembly 2.

The negative electrode assembly 1 includes a negative electrode 10 that is disposed in opposition to a positive electrode 20 and that has a negative electrode active material layer 13 formed on one surface of a negative electrode current collector 11, and a second non-porous polymer film layer 35 that is formed to cover the negative electrode active material layer 13.

In addition, according to a third embodiment of the present invention shown in FIG. 3, a negative electrode assembly 1a includes negative electrode active material layers 13 and 13a that are respectively formed on both surfaces of a negative electrode current collector 11. It is also possible to form second non-porous polymer film layers 35 and 35a to cover the negative electrode active material layers 13 and 13a, respectively.

Moreover, it is also possible to form porous polymer web layers that are made of ultrafine fibers of a mixture of a heat-resistant polymer and inorganic particles or a mixture of a heat-resistant polymer, a swellable polymer, and inorganic particles, on surfaces of the second non-porous polymer film layers 35 and 35a, respectively.

Meanwhile, the positive electrode assembly 2 includes a positive electrode 20 having a positive electrode active material layer 23 formed on one surface of a positive electrode current collector 21, a first non-porous polymer film layer 31 formed to cover the positive electrode active material layer 23, and an inorganic matter containing porous polymer web layer 33 that is formed on the first non-porous polymer film layer 31 and is made of ultrafine fibers of a mixture of a heat-resistant polymer and inorganic particles or a mixture of a heat-resistant polymer, a swellable polymer, and inorganic particles.

In addition, as shown in FIG. 2, a positive electrode assembly 2a includes positive electrode active material layers 23 and 23a that are respectively formed on both surfaces of a positive electrode current collector 21, and it is also possible to form first non-porous polymer film layers 31 and 31a to cover the positive electrode active material layers 23 and 23a, respectively, and porous polymer web layers 33 and 33a that are made of ultrafine fibers of a mixture of a heat-resistant polymer and inorganic particles or a mixture of a heat-resistant polymer, a swellable polymer, and inorganic particles, on surfaces of the first non-porous polymer film layers 31 and 31a, respectively.

The positive electrode active material layers 23 and 23a include respective positive electrode active materials that can reversibly perform intercalation and deintercalation of lithium ions and typical examples of the positive electrode active materials include lithium-transition metal oxides such as LiCoO₂, LiNiO₂, LiMnO₂, LiMn₂O₄, or LiNi_{1-x-y}CoₓMyO₂ wherein 0≦x≦1, 0≦y≦1, 0≦x+y≦1, and M is a metal such as Al, Sr, Mg, and La). In the present invention, however, it is of course possible to use other kinds of positive electrode active materials other than the positive electrode active materials.

The negative electrode active materials 13 and 13a include respective negative electrode active materials that can reversibly perform intercalation and deintercalation of lithium ions and typical examples of the negative electrode active materials include crystalline or amorphous carbon, or carbon composite carbon-based negative electrode active materials. However, the present invention is not limited to the above types of the negative electrode active materials.

The second non-porous polymer film layers 35 and 35a formed to cover the negative electrode active material layers 13 and 13a, in the negative electrode assemblies 1 and 1a, respectively, may include a polymer that is swellable in an electrolyte solution and allows conduction of electrolyte ions, for example, any one of PVDF (PolyVinyliDene Fluoride), PEO (Poly-Ethylen Oxide), PMMA (PolyMethylMethAcrylate), and TPU (Thermoplastic PolyUrethane). In addition, the second non-porous polymer film layers 35 and 35a are respectively obtained through processes of: dissolving a polymer that is swellable in an electrolyte solution and allows conduction of electrolyte ions, in a solvent, to thus form a spinning solution; electrospinning the spinning solution on the negative electrode active material layer, to thus form ultrafine fibrous porous polymer webs; and calendering or heat-treating the porous polymer webs at a temperature lower than a melting point of the polymer (for example, PVDF).

Since a residual solvent remains in the polymer web, it is possible to execute the heat-treating process at a heat-treatment temperature slightly lower than the melting point of the polymer. In addition, the heat-treating process is executed to prevent the polymer web from being completely melted and to form a non-porous film.

As described above, the non-porous polymer film layers 35 and 35a that are respectively made of the materials that are swellable in an electrolyte solution and allows conduction of electrolyte ions are directly electrospun on the surfaces of the negative electrode active material layers 13 and 13a to then be formed close to the surfaces of the negative electrode active material layers 13 and 13a, to thereby maintain conduction of lithium ions and also prevent formation of a space between the negative electrode 10 and the film, and to thus prevent the lithium ions from being accumulated and precipitated into a lithium metal. As a result, formation of dendrites may be inhibited on the surface of the negative electrode 10, to thus promote improvement of a stability of a battery.

As shown in FIGS. 1 and 2, the respective positive electrodes 20 in the positive electrode assembly 2 or 2a include the positive electrode active material layers 23 and 23a on one or both surfaces of the positive electrode current collector 21. The conventional separator that separates the positive electrode 20 and the negative electrode 10 includes the first non-porous polymer film layer 31 or 31a and the inorganic matter contained porous polymer web layer 33 or 33a.

The first non-porous polymer film layers 31 and 31a to respectively cover the positive electrode active material layers 23 and 23a act as an adhesive layer, and are formed in a similar manner to that of the second non-porous polymer film layer.

In other words, the first non-porous polymer film layers 31 and 31a are respectively obtained through processes of dissolving a polymer that is swellable in an electrolyte solution and allows conduction of electrolyte ions, in a solvent, to thus form a spinning solution; electrospinning the spinning solution on the negative electrode active material layer, to thus form ultrafine fibrous porous polymer webs; and calendering or heat-treating the porous polymer webs at a temperature lower than a melting point of the polymer (for example, PVDF).

The inorganic matter containing porous polymer web layers 33 and 33a that are respectively formed on the first non-porous polymer film layers 31 and 31a, are formed through processes of: dissolving a mixture of a heat-resistant polymer and inorganic particles or a mixture of a heat-resistant polymer, a swellable polymer, and inorganic particles, in a solvent, to thus form a spinning solution; electrospinning the spinning solution on the first non-porous polymer film layers 31 and 31a, respectively, to form an ultrafine fibrous porous polymer web; and calendering the porous polymer web at a temperature lower than a melting point of the polymer.

The inorganic particles may include at least one selected from the group consisting of TiO₂, BaTiO₃, Li₂O, LiF, LiOH, Li₃N, BaO, Na₂O, Li₂CO₃, CaCO₃, LiAlO₂, SiO₂, Al₂O₃, S10, SnO, SnO₂, PbO₂, ZnO, P₂O₅, CuO, MoO, V₂O₅, B₂O₃, Si₃N₄, CeO₂, Mn₃O₄, Sn₂P₂O₇, Sn₂B₂O₅, and Sn₂BPO₆, and a mixture thereof.

In the case of the mixture of the heat-resistant polymer and the inorganic particles, or the mixture of the heat-resistant polymer, the swellable polymer, and the inorganic particles, it is preferable that a content of the inorganic particles is in a range of 10 to 25 wt % for the whole mixture, when a size of the inorganic particles is between 10 to 100 nm. More preferably, a content of the inorganic particles is in a range of 10 to 20 wt % for the whole mixture, and a size of the inorganic particles is between 15 to 25 nm.

In the case that a content of the inorganic particles is less than 10 wt % for the whole mixture, a film shape is not maintained, contraction occurs, and a desired heat-resistant property is not obtained. In the case that a content of the inorganic particles exceeds 25 wt % for the whole mixture, a spinning trouble phenomenon that contaminates a spinning nozzle tip occurs, and the solvent quickly evaporates, to thus lower strength of the film.

In addition, in the case that a size of the inorganic particles is less than 10 nm, a volume is too large bulky and thus it is cumbersome to handle the mixture. In the case that a size of the inorganic particles exceeds 100 nm, a phenomenon of lumping the inorganic particles occurs and thus a lot of the inorganic particles are exposed out of the fibers, to thereby cause the strength of the fibers to drop. In addition, it is preferable that the inorganic particles have sizes smaller than diameters of fibers so as to be included in nano-fibers. In the case that a small quantity of the inorganic particles having larger sizes than diameters of fibers are mixed and used, ionic conductivity may be improved unless the strength and spinning performance are interfered.

In addition, in the case of the mixture of the heat-resistant polymer, the swellable polymer, and the inorganic particles, it is preferable that the heat-resistant polymer and the swellable polymer are mixed at a weight ratio in a range of 5:5 to 7:3. More preferably, the heat-resistant polymer and the swellable polymer are mixed at a weight ratio of 6:4. In this case, the swellable polymer is added as a binder role that helps bonding between the fibers.

In the case that a mixing ratio of the heat-resistant polymer and the swellable polymer is smaller than 5:5 at a weight ratio, a heat-resistant property drops and a required high temperature property is not obtained. In the case that a mixing ratio of the heat-resistant polymer and the swellable polymer is larger than 7:3 at a weight ratio, strengths of the fibers fall down and a spinning trouble occurs.

The heat-resistant polymer resin that may be used in the present invention is a resin that can be dissolved in an organic solvent for electrospinning and whose melting point is 180° C. or higher, for example, any one selected from the group consisting of: aromatic polyester containing at least one of polyacrylonitrile (PAN), polyamide, polyimide, polyamide-imide, poly (meta-phenylene iso-phthalamide), polysulfone, polyether ketone, polyethylene terephthalate, polytrimethylene terephthalate, and polyethylene naphthalate; polyphosphazenes containing at least one of polytetrafluoroethylene, polydiphenoxy phosphazene, and poly {bis[2-(2-methoxyethoxy)phosphazene]}; polyurethane copolymer containing at least one of polyurethane and polyether urethane; cellulose acetate, cellulose acetate butylrate, and cellulose acetate propionate.

The swollen polymer material that may be used in the present invention is a resin that is swollen in an electrolyte, and may be formed into an ultrafine fiber by an electrospinning method, for example, any one selected from the group consisting of: polyvinylidene fluoride (PVDF), poly (vinylidene fluoride-co-hexafluoropropylene), perfluoropolymer, polyvinyl chloride or polyvinylidene chloride, and copolymer thereof; polyethylene glycol derivatives containing at least one of polyethylene glycol dialkylether and polyethylene glycol dialkyl ester; polyoxide containing at least one of poly (oxymethylene-oligo-oxyethylene), polyethylene oxide and polypropylene oxide; polyacrylonitrile copolymer containing at least one of polyvinyl acetate, poly (vinyl pyrrolidone-vinyl acetate), polystyrene, polystyrene acrylonitrile copolymer, and polyacrylonitrile methyl methacrylate copolymer; and polymethyl methacrylate, and polymethyl methacrylate copolymer, and any one combination thereof.

Meanwhile, the respective non-porous polymer film layers 31 and 31a have been used to cover the positive electrode active material layers 23 and 23a and as adhesive layers of the positive electrode active material layers 23 and 23a, in the description of the present invention, but it is also possible to use a porous polymer web that is obtained by electrospinning a swellable polymer.

For example, the porous polymer web is formed by processes of: dissolving a swellable polymer in a solvent to thus form a spinning solution; electrospinning the spinning solution on a negative electrode active material layer, to thus form the porous polymer web made of ultrafine fibers; and calendaring the porous polymer web at a temperature lower than a melting point of the polymer such as PVDF.

Meanwhile, in the above-described examples, the inorganic matter containing porous polymer web layers 33 and 33a having the excellent heat resistance properties are respectively provided on the surfaces of the positive electrode assemblies 2 and 2a, but it is also possible for the inorganic matter containing porous polymer web layers 33 and 33a to cover the positive electrode active material layers 23 and 23a, respectively, and for the porous polymer web layers to be formed on the inorganic matter containing porous polymer web layers 33 and 33a, respectively. In this case, the porous polymer layers that are respectively exposed on the surfaces of the positive electrode assemblies 2 and 2a, may be formed by using, for example, a heat-resistant polymer such as PAN (PolyAcryloNitrile) or a swellable polymer such as PVDF.

In this case, it is also possible to respectively form the porous polymer web layers on the upper surfaces of the inorganic matter containing porous polymer web layers that cover the positive electrode active material layers 23 and 23a, respectively, and to respectively form the non-porous film layers by heat-treating the porous polymer web layers at a temperature lower than the melting points of the porous polymer web layers. It is preferable to use a polymer that is swellable in an electrolyte solution and allows conduction of electrolyte ions, that is, PVDF, as a material that is used to form the non-porous film layers.

The porous polymer web layer is formed through processes of: dissolving a mixture of a mixture of a heat-resistant polymer, a swellable polymer, and inorganic particles, in a solvent, to thus form a spinning solution; electrospinning the spinning solution to form a porous polymer web; and calendering the porous polymer web at a temperature below the melting point of the polymer.

In addition, in this case, when the second non-porous polymer film layers 35 and 35a are respectively formed in the negative electrode assemblies 1 and 1a, it is also possible to respectively form the second non-porous polymer film layers 35 and 35a containing the inorganic matters, through processes of: mixing inorganic particles with a polymer that is swellable in an electrolyte solution and allows conduction of electrolyte ions; electrospinning the mixture of the inorganic particles and the polymer; and calendering or heat treating an obtained porous polymer web at a temperature lower than the melting point of the polymer.

Moreover, according to the first to third embodiments of the present invention, illustrated in FIGS. 1 to 3, the first and second non-porous polymer film layers 31 and 31a; 35 and 35a and the inorganic matter containing porous polymer web layers 33 and 33a that respectively act as separators in electrode assemblies, have been illustrated with the structure that they are respectively separated from each other on both sides of the positive electrode 20 and the negative electrode 10, but is also possible to respectively form the first and second non-porous polymer film layers 31 and 31a; 35 and 35a and the inorganic matter containing porous polymer web layers 33 and 33a, on any one side of the positive electrode 20 and the negative electrode 10.

For example, the second non-porous polymer film layers 35 and 35a, the inorganic matter containing porous polymer web layers 33 and 33a, and the first non-porous polymer film layers 31 and 31a may be sequentially formed to cover the negative electrode active material layers 13 and 13a in the negative electrode assemblies 1 and 1a, respectively.

In addition, it is also possible to form the second non-porous polymer film layers 35 and 35a and the inorganic matter containing porous polymer web layers 33 and 33a, to cover the negative electrode active material layers 13 and 13a in the negative electrode assemblies 1 and 1a, respectively, and to form the first non-porous polymer film layers 31 and 31a and the inorganic matter containing porous polymer web layers 33 and 33a on the surfaces of the positive electrode assemblies 2 and 2a, respectively. In this case, the inorganic matter containing porous polymer web layers 33 and 33a are adhered with each other when the negative electrode assemblies 1 and 1a and the positive electrode and assemblies 2 and 2a are assembled, respectively.

Moreover, on the contrary, it is also possible to form the second non-porous polymer film layers 35 and 35a and the porous polymer web layers 33 and 33a, to cover the negative electrode active material layers 13 and 13a in the negative electrode assemblies 1 and 1a, respectively, and to form the first non-porous polymer film layers 31 and 31a and the porous polymer web layers 33 and 33a, to cover the positive electrode active material layers 23 and 23a in the positive electrode assemblies 2 and 2a, respectively.

As described above, in the present invention, the first and second non-porous polymer film layers 31 and 31a; 35 and 35a and the inorganic matter containing porous polymer web layers 33 and 33a that respectively act as separators in electrode assemblies, have been illustrated with the structure that they are respectively separated from each other on the positive electrode 20 and the negative electrode 10, but it is also possible to respectively form three layers 31,31a, 33,33a and 35,35a or two layers 31,31a and 33,33a only on the positive electrode 20 or on the negative electrode 10.

In this case, when the non-porous polymer film layers 31 and 31a and the inorganic matter containing porous polymer web layers 33 and 33a are formed only on the positive electrode 20, it is also possible to form the inorganic matter containing porous polymer web layers 33 and 33a in advance to cover the positive electrode active material layers 23 and 23a so that the non-porous polymer film layers 31 and 31a contact the negative electrode 10.

The inorganic matter containing porous polymer web layers 33 and 33a and the first non-porous polymer film layers 31 and 31a are integrally formed on the positive electrode 20, the inorganic matter containing porous polymer web layers 33 and 33a are preferably set in the range of 5 to 50 μm thick, and the first non-porous polymer film layers 31 and 31a are preferably set in the range of 5 to 14 μm thick.

In this case, the function of separator is more sensitive to the thicknesses of the first non-porous polymer film layers 31 and 31a than the inorganic matter containing porous polymer web layers 33 and 33a, because the inorganic matter containing porous polymer web layers 33 and 33a have higher porosity than the first non-porous polymer film layers 31 and 31a. As shown in FIGS. 9 to 13, when the first non-porous polymer film layers 31 and 31a is less than 5 μm thick, a micro short circuit occurs, and when it is more than 14 μm thick, it is too thick to perform charging and discharging because movement of the Li ions are blocked. It is desirable that thicknesses of the first non-porous polymer film layers 31 and 31a are adjusted considering the ionic conductivities and the energy densities of the film layers.

In addition, according to the present invention, it is also possible to form inorganic matter containing porous polymer web layers 33 and 33a on the positive electrode 20, and second non-porous polymer film layers 35 and 35a on the negative electrode 10, respectively, to thus play a role of a separator of two layers.

Furthermore, the first non-porous polymer film layers 31 and 31a and the inorganic matter containing porous polymer web layers 33 and 33a that are integrally formed on the positive electrode 20 have been illustrated in the above-described embodiment, but it is possible to prepare the first non-porous polymer film layers 31 and 31a and the inorganic matter containing porous polymer web layers 33 and 33a as a separator of a 2-layer or 3-layer structure, and then insert the separator between two electrodes in an assembly process of the electrodes.

In addition, it is also possible to combine the inorganic matter containing porous polymer web layers 33 and 33a, with inorganic matter excluding porous polymer film layers, instead of the non-porous polymer web layers 31 and 31a.

After that, the two electrodes are stacked, or are wound after being stacked, to thereby form an electrode assembly.

As mentioned above, since the first and second non-porous polymer film layers 31 and 31a; 35 and 35a and the inorganic matter containing porous polymer web layers 33 and 33a may serve as a separator for themselves, it may be omitted to provide a separate separator between the two electrodes.

The conventional film type of separator has a problem with shrinkage at high temperatures, but since inorganic matters are contained in the porous polymer web layers 33 and 33a in the present invention, the porous polymer web layers 33 and 33a do not shrink and melt even when being annealed at 500° C. but stay in shape.

The conventional polyolefin-based film type separator may cause a hard short circuit since a peripheral film type separator is continuously shrunken or melted in addition to a damaged portion by an initial heat generation when an internal short circuit has occurred, to thus cause a burnt and lost portion of the film type separator to become wider, but the electrodes according to the present invention do not lead to a widening phenomenon of the short circuit portion, but there may be a small damage in an area where an internal short circuit has happened.

Also, the electrodes of the present invention cause a very tiny soft short circuit not a hard short circuit, even at the time of overcharging, to thus continuously cause overcharging current consumption and to maintain a constant voltage between 5V and 6V and a battery temperature of 100° C. or less. Accordingly, overcharging stability may be also improved.

A secondary battery according to the present invention, includes an electrolyte solution in an electrode assembly having a separator.

The electrolyte solution according to the present invention includes a non-aqueous organic solvent, and the non-aqueous organic solvent may include carbonate, ester, ether, or ketone. The carbonate may include dimethyl carbonate (DMC), diethyl carbonate (DEC), dipropyl carbonate (DPC), methylpropyl carbonate (MPC), ethylpropyl carbonate (EPC), methylethyl carbonate (MEC), ethylene carbonate (EC), propylene carbonate (PC), butylene carbonate (BC), and the like. The ester may include butyrolactone (BL), decanolide, valerolactone, mevalonolactone, caprolactone, n-methyl acetate, n-ethyl acetate, n-propyl acetate, and the like. The ether may include dibutyl ether, etc. The ketone may include poly methyl vinyl ketone. However, the present invention is not limited to the non-aqueous organic solvent.

In addition, the electrolyte solution according to the present invention includes a lithium salt, and the lithium salt acts as a source of lithium ions within a cell and enables a basic operation of a lithium battery. The examples of the lithium salt may be at least one selected from the group consisting of LiPF₆, LiBF₄LiSbF₆, LiAsF₆, LiClO₄LiCF₃SO₃, LiN(CF₃SO₂)₂, LiN(C₂F₅SO₂)₂, LiAlO₄LiAlCl₄LiN(CₓF₂ₓ₊₁SO₂)(C_{y}F₂ₓ₊₁SO₂) (here, x and y are natural numbers, respectively) and LiSO₃CF₃, or a mixture thereof.

As mentioned above, the positive electrode assembly 2 or 2a and the negative electrode assembly 1 or 1a are combined to then form an electrode assembly. Thereafter, the electrode assembly is contained in an aluminum or aluminum alloy can or a similar container, to then close an opening portion with a cap assembly and inject an electrolyte solution in the electrode assembly and to thereby manufacture a lithium secondary battery.

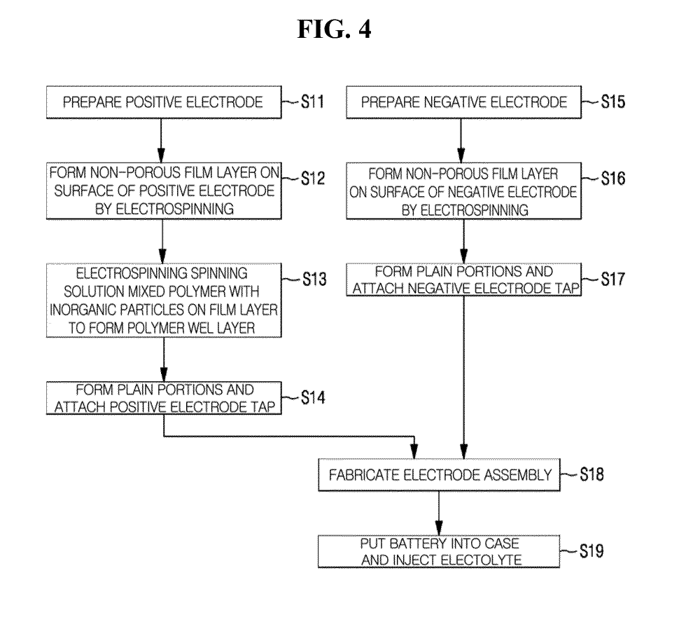

On the following, referring to FIGS. 4 to 9, a method of manufacturing a secondary battery according to the present invention will be described.

First, according to well-known methods, a positive electrode 20 having a positive electrode active material layer 23 formed on at least one surface of a positive electrode current collector 21, and a negative electrode 10 having a negative electrode active material layer 13 formed on at least one surface of a negative electrode current collector 11, are prepared, respectively (S11 and S15).

Subsequently, a first non-porous polymer film layer 31 is formed to cover the positive electrode active material layer 23 (S12). The first non-porous polymer film layer 31 is formed through processes of: dissolving a polymer that is swellable in an electrolyte solution and allows conduction of electrolyte ions, in a solvent, to thus form a spinning solution; electrospinning the spinning solution on the positive electrode active material layer 23, to thus form an ultrafine fibrous porous polymer web; and heat-treating or calendering the porous polymer web at a somewhat lower temperature than a melting point of the polymer.

Since a residual solvent remains in the polymer web, it is possible to execute the heat-treating process at a heat-treatment temperature slightly lower than the melting point of the polymer. In addition, the heat-treating process is executed to prevent the polymer web from being completely melted and to form a non-porous film.

Any one of a typical electrospinning method, an air-electrospinning (AES) method, an electrospray method, an electrobrown spinning method, a centrifugal electrospinning method, and a flash-electrospinning method, may be used as a spinning method that is applied in the present invention.

In this case, a polymer material that is desirable for forming the first non-porous polymer film layer 31 may be PVDF that is a polymer that is swellable in an electrolyte solution and allows conduction of electrolyte ions.

Then, a porous polymer web layer 33 made of ultrafine fibers of a mixture of a heat-resistant polymer and inorganic particles or a mixture of a heat-resistant polymer, a swellable polymer, and inorganic particles, is formed on the first non-porous polymer film layer 31 (S13). The inorganic matter containing porous polymer web layer is obtained through processes: dissolving a mixture of a heat-resistant polymer and inorganic particles or a mixture of a heat-resistant polymer, a swellable polymer, and inorganic particles, in a solvent, to thus form a spinning solution; electrospinning, preferably, air-electrospinning the spinning solution on the first non-porous polymer film layer 31 to form an ultrafine fibrous porous polymer web; and calendering the porous polymer web.

In the case that a heat-resistant polymer (for example, PAN) and a swellable polymer are dissolved in a solvent, to thus form a spinning solution, a content of the polymer mixture for the spinning solution is preferably included in a range of 10 to 13 wt %. In the case that a content of the polymer mixture is less than 10 wt %, beads occur to thereby cause a problem that the beads blow. In the case that a content of the polymer mixture exceeds 13 wt %, there is a problem that a phenomenon of solidifying or curing spinning nozzle tips may occur.

After that, in order to form plain portions to which a positive electrode tab is attached, the porous polymer web layer 33 and the first non-porous polymer film layer 31 are selectively removed, to then make the positive electrode tab that serves as the positive electrode terminal attached to the plain portions (S14).

In the secondary battery manufacturing method shown in FIG. 4, the first non-porous polymer film layer 31 and the porous polymer web layer 33 that play a role of a separator are integrally formed on the positive electrode 20, in advance, and then the plain portions are formed and the positive electrode tab is attached to the plain portions, but the present invention is not limited thereto, and may be modified.

In other words, when the inorganic matter containing porous polymer web layers 33 and 33a and the first non-porous polymer film layers 31 and 31a are sequentially formed at a state of masking a terminal portion where the positive terminal 21a is formed, a process of forming plain portions may be excluded.

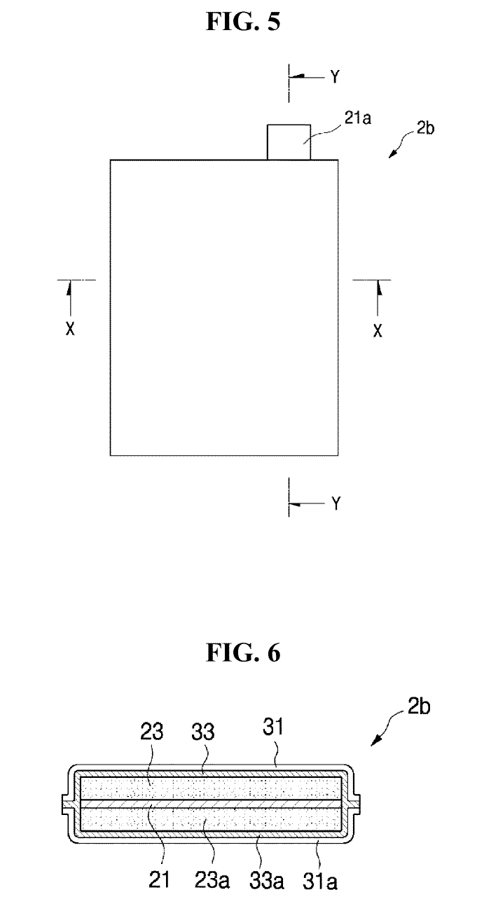

FIGS. 5 to 7 illustrate a positive electrode assembly according to a fourth embodiment.

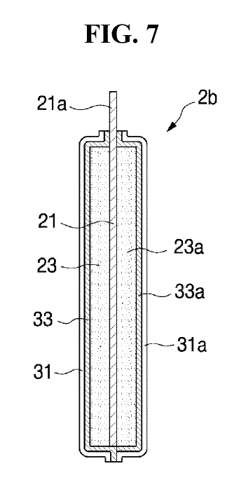

As shown in FIGS. 6 and 7, the positive electrode assembly 2b is formed to have a form that the inorganic matter containing porous polymer web layers 33 and 33a and the first non-porous polymer film layers 31 and 31a surround the positive electrode active materials 23 and 23a and the current collector 21 to thereby achieve improvement of safety.

For this purpose, width of spinning the nano-fibers for forming the inorganic matter containing porous polymer web layers 33 and 33a and the first non-porous polymer film layers 31 and 31a is set larger than the size of the positive electrode active materials 23 and 23a, to thereby execute electrospinning.

Meanwhile, a second non-porous polymer film layer 35 is formed to cover the positive electrode active material layer 13 to thereby form the negative electrode assembly 1 (S16).

Then, in order to form plain portions to which a negative electrode tab is attached, the second non-porous polymer film layer 35 is selectively removed, to then make the negative electrode tab attached to the plain portions (S17).

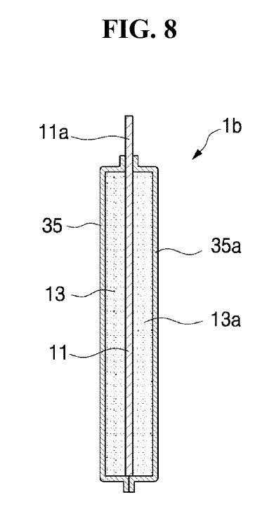

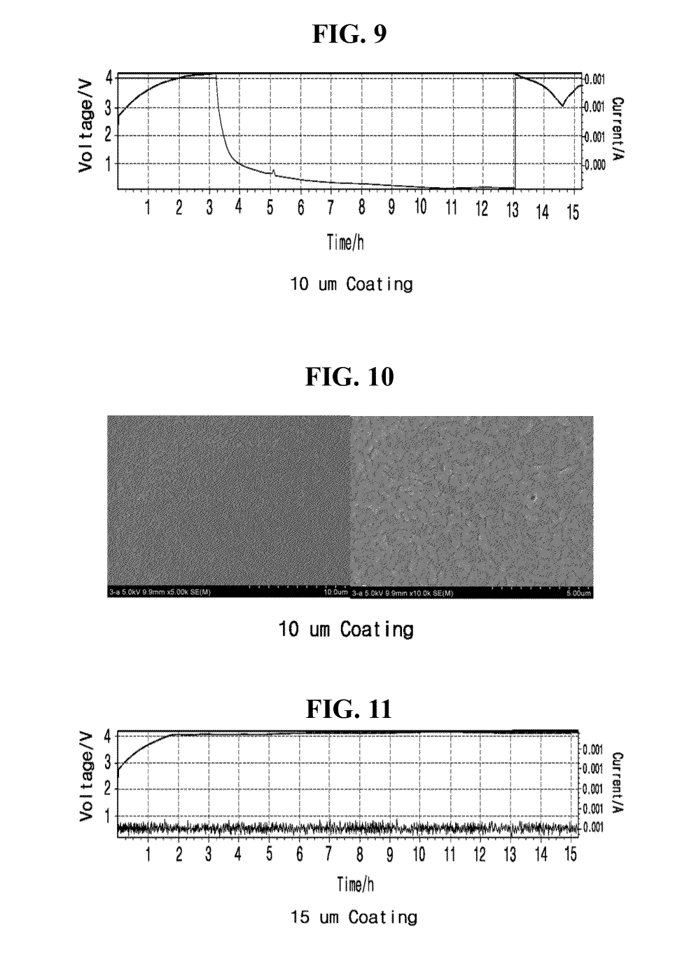

Like the positive electrode even in the case of the negative electrode tab, when the second non-porous polymer film layers 35 and 35a are formed at a state of masking a terminal portion where the negative terminal 11a is formed, a process of forming plain portions may be excluded as shown in FIG. 8.

In addition, the negative electrode assembly 1b is formed to have a form that the second non-porous polymer film layers 35 and 35a surround the negative electrode active materials 13 and 13a and the current collector 11.

As a result, in this invention, non-porous films 35 and 35a made of a material that is swellable in an electrolyte solution and allows conduction of electrolyte ions are directly electrospun on a surface of a negative electrode 10 to then be formed close to the surface of the negative electrode, and to thus remove formation of a space between the negative electrode and the film while maintaining the ion conductivity. Thus, the present invention prevents lithium ions from being accumulated to then be precipitated into a lithium metal, and to thereby inhibit formation of dendrites and to thus promote improvement of a stability of a battery.

After that, the positive electrode assembly 2 and the negative electrode assembly 1 are made to oppose each other, to then be compressed and assembled and to thus form a unit cell (S18). Thereafter, the unit cell is built in a battery case and then an electrolyte solution is injected (S19).

In this manner, the positive electrode assembly 2b and the negative electrode assembly 1b that are obtained as shown in FIGS. 7 and 8 are made to oppose each other, to then be compressed and assembled, and to thus form a unit cell (S18). Thereafter, the unit cell is built in a battery case and then an electrolyte solution is injected, to thereby complete an assembly of a secondary battery (S19).

In this case, the unit cell is a bicell in which electrodes formed on both sides of the bicell have the same structure as shown in FIGS. 7 and 8, or a full cell in which electrodes formed on both sides of the full cell have the different structures as shown in FIG. 1.

In addition, in the present invention, in order to configure high-capacity batteries for electric vehicles, a multiple of unit cells are simply stacked, and then a case assembly process proceeds, to thus be produced in large-sized batteries. Thus, the present invention has a high assembly productivity, in comparison with conventional techniques of going through a process of folding a number of bicells or full cells with separate separator films.

In the description of the subsequent embodiments, the first and second non-porous polymer film layers 31 and 31a; 35 and 35a and the inorganic matter containing porous polymer web layers 33 and 33a serving as separators are integrally formed on the negative electrode and positive electrode, and the negative electrode active materials 13 and 13a, the positive electrode active material layers 23 and 23a, the electrolyte solution do not withstand a 500° C. heat-treatment test in the secondary batteries where the negative electrode and positive electrode have been assembled, and thus the 500° C. heat-treatment test has been conducted in the form of separators where the negative electrode and positive electrode have been separated.

Hereinbelow, the present invention will be described in detail through the preferred embodiments. However, the following embodiments are only illustrative of the present invention, and the scope of the present invention is not limited thereto.

<Charge and Discharge Characteristics According to Thickness of Non-Porous Film Layers in a Two-Layer Structure of a Separator>

### Example 1

### PAN/PVDF (6/4) 11 wt % Web DMAc Solution+PVDF 22 wt % Film (Acetone:DMAc=2:8)

In order to manufacture a separator made of heat-resistant nano-fibers by an air-electrospinning (AES) method, polyacrylonitrile (PAN) of 6.6 g and polyvinylidene fluoride (PVDF) of 4.4 g were added to dimethylacetamide (DMAc) of 89 g serving as a solvent, and stirred at 80° C., to thus have prepared a mixed spinning solution made of a heat-resistant polymer and a swellable polymer.

The spinning solution consists of different phases from each other with respect to the heat-resistant polymer and the swellable polymer. Accordingly, phase separation may occur rapidly. Therefore, the spinning solution was put into a mixing tank and stirred using a pneumatic motor to then discharge a polymer solution at 17.5 μl/min/hole. Here, temperature of the spinning section was maintained at 33° C. and humidity thereof was maintained to 60%, while applying a voltage of 100 KV to a spin nozzle pack using a high voltage generator and at the same time an air pressure of 0.25 MPa to the spin nozzle pack, to thus have formed a first porous polymer web layer made of ultrafine nano-fibers with a mixture of PAN and PVDF.

Subsequently, a second porous polymer web layer was continuously formed to the first porous polymer web layer. In other words, polyvinylidene fluoride (PVDF) of 22 g were added to a solvent of a mixture of dimethylacetamide (DMAc) of 62.4 g and acetone of 15.6 g, and stirred at 80° C., to thus have prepared a spinning solution. The spinning solution was put into the mixing tank to then discharge a polymer solution by 22.5 μl/min/hole. Here, temperature and humidity of the spinning section were the same as those of the spinning section of making the first porous polymer web layer. While applying a voltage of 100 KV to a spin nozzle pack using another high voltage generator and at the same time applying an air pressure of 0.2 MPa to the spin nozzle pack, a second porous polymer web layer was formed.

The two-layer structure of the first and second porous polymer web layers with different melting points underwent a subsequent heat treatment of passing through 120° C. infrared (IR) lamp, and thus the second porous polymer web layer made of PVDF was transformed into a non-porous film phase.

Then, the two-layer structure of the first porous polymer web layer and the non-porous polymer film layer were moved to calender equipment. Calendering was performed using a heating/pressurizing roll, and then, in order to remove the solvent and moisture that may remain, the first porous polymer web layer and the non-porous polymer film layer were made to pass through a hot-air dryer at a temperature of 100° C. and with a wind speed of 20 m/sec, to thus have obtained a two-layer structure of a separator.

The thus-obtained two-layer structure of the separator was measured as total thickness of 15 μm in which thickness of the first porous polymer web layer was 5 μm and thickness of the non-porous film layer was 10 μm.

By conducting a charging and discharging test of a 2 Ah grade battery where the obtained separator of Example 1 was applied, a graph of the measured charge and discharge characteristics was shown in FIG. 9, and a Scanning Electron Microscopy (SEM) photo for the non-porous film layer was shown in FIG. 10.

### Comparative Examples 1 to 3

In the case of Comparative Examples 1 to 3, a two-layer structure of a separator was fabricated, in which all conditions were applied in the same manner as in Example 1, except that thickness of the first porous polymer web layer was maintained as 5 μm, and thicknesses of the non-porous film layers were set differently as 4 μm in Comparative Example 1, 15 μm in Comparative Example 2, and 25 μm in Comparative Example 3.

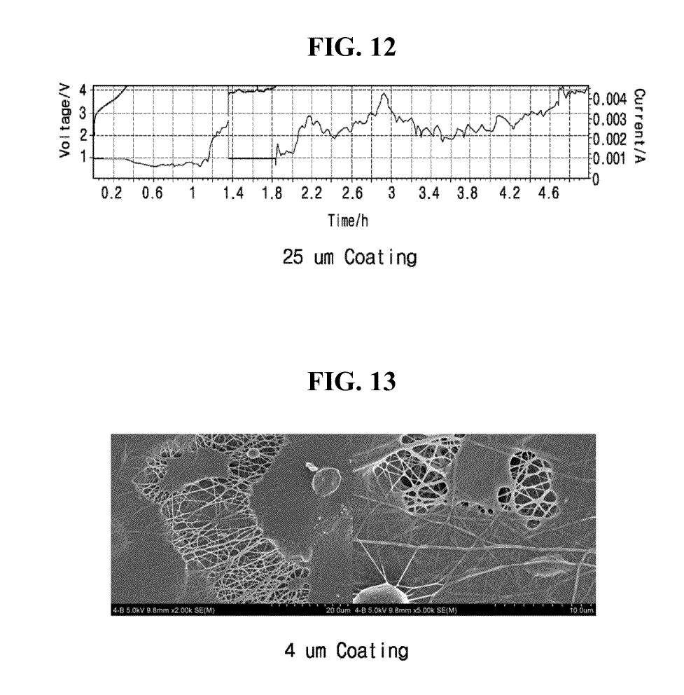

By conducting a charging and discharging test of a 2 Ah grade battery where the obtained separator of Comparative Example 2 was applied, graphs of the measured charge and discharge characteristics were shown in FIGS. 11 and 12, and a Scanning Electron Microscopy (SEM) photo of the Comparative Example 1 was shown in FIG. 13.

Referring to FIGS. 9 to 12, in the case of the separator of Comparative Example 1 in which the thickness of the non-porous film layer was 4 μm, the non-porous film layer was partially molten and thus a micro short circuit occurred, but if the thickness of the non-porous film layer was 5 μm, a micro short circuit did not occur.

In addition, in the case that thickness of the non-porous film layer is 15 μm, as in Comparative Example 2, or thickness of the non-porous film layer is 25 μm, as in Comparative Example 3, charging and discharging was not been made as shown in FIGS. 11 and 12.

<Charging Capacity According to C-Rate>

### Example 2

In the case of Example 2, a two-layer structure of a separator was fabricated, in which all conditions were applied in the same manner as in Example 1, except that a total thickness of the separator was set as 20 μm, in which the first porous polymer web layer was set as 13 μm, and thickness of the non-porous film layer was set as 7 μm, and then characteristics of the measured charging capacity according to C-rate of a 2 Ah grade battery where the obtained separator of Example 2 was applied were represented in Table 1.

### Comparative Example 4

### PAN/PVDF (6/4) 11 wt % web DMAc Solution

In order to manufacture a separator made of heat-resistant nano-fibers by an air-electrospinning (AES) method, polyacrylonitrile (PAN) of 6.6 g and polyvinylidene fluoride (PVDF) of 4.4 g were added to dimethylacetamide (DMAc) of 89 g serving as a solvent, and stirred at 80° C., to thus have prepared a mixed spinning solution made of a heat-resistant polymer and a swellable polymer.

The spinning solution consists of different phases from each other with respect to the heat-resistant polymer and the swellable polymer. Accordingly, phase separation may occur rapidly. Therefore, the spinning solution was put into a mixing tank and stirred using a pneumatic motor to then discharge a polymer solution at 17.5 μl/min/hole. Here, temperature of the spinning section was maintained at 33° C. and humidity thereof was maintained to 60%, while applying a voltage of 100 KV to a spin nozzle pack using a high voltage generator and at the same time an air pressure of 0.25 MPa to the spin nozzle pack, to thus have formed a porous polymer web layer made of ultrafine nano-fibers with a mixture of PAN and PVDF.

Then, the one-layer structure of the porous polymer web layer was moved to calender equipment. Calendering was performed using a heating/pressurizing roll, and then, in order to remove the solvent and moisture that may remain, the porous polymer web layer was made to pass through a hot-air dryer at a temperature of 100° C. and with a wind speed of 20 m/sec, to thus have obtained the separator of 20 μm thick.

Characteristics of the measured charging capacity according to C-rate of a 2 Ah grade battery where the obtained separator of Comparative Example 4 was applied were represented in Table 1.

### Comparative Examples 5 and 6

In Comparative Example 5, a 3-layer structure, that is, a PP/PE/PP structure of a separator (model number Celgard® 2320 of Cellgard LLC) was used, and in Comparative Example 6, a separator where a ceramic coating was applied with inorganic particles and a binder was used in order to enhance the heat resistance properties of the separator of Comparative Example 5. Then, characteristics of the charging capacities measured according to C-rate of 2 Ah grade batteries where the obtained separators of Comparative Examples 5 and 6 were applied were represented in Table 1.

TABLE 1
Capacity (%)

| | Comparative | Comparative | Comparative | |
|---|---|---|---|---|
| | Example 5 | Example 6 | Example 4 | Example 2 |
| 0.2 C | 100.00 | 100.00 | 100.00 | 100.00 |
| 0.5 C | 89.72 | 96.24 | 92.59 | 94.47 |
| 1 C | 85.98 | 86.85 | 86.57 | 88.48 |
| 2 C | 70.09 | 53.05 | 75.00 | 63.13 |

Referring to Table 1, the charge capacity characteristics of the separator in Example 2 were somewhat lower in 2C than that of the separator made of the porous polymer web consisting of PAN/PVDF in Comparative Example 4, but appeared to have the same characteristics as those of Comparative Example 5, or to have more excellent characteristics as those of Comparative Example 6 that enhance heat resistance properties.

<Discharging Capacity According to C-Rate>

### Examples 3 and 4

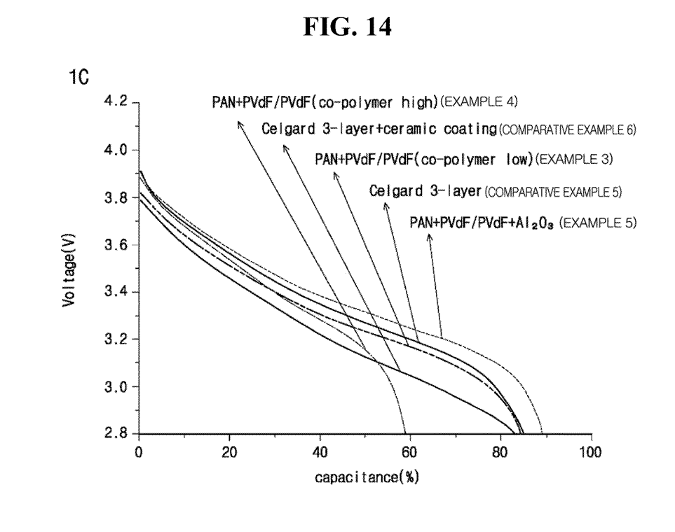

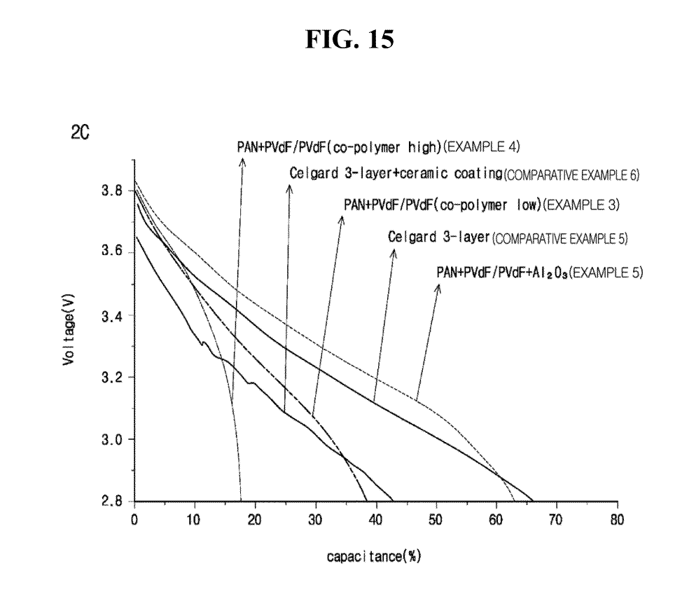

In Example 3, a two-layer structure of a separator was manufactured in which a low content of a co-polymer was used in PVDF of PAN and PVDF that form the first porous polymer web layer in Example 2. In Example 4, a two-layer structure of a separator was manufactured in which a high content of a co-polymer was used in PVDF of PAN and PVDF that form the first porous polymer web layer in Example 2. In Examples 3 and 4, all the other conditions were same as those of Example 2. Characteristics of the discharging capacities measured according to 1C-rate and 2C-rate of 2 Ah grade batteries where the obtained separators of Examples 3 and 4 were applied were shown in FIGS. 14 and 15, respectively.

### Example 5

### PAN/PVDF (6/4) 11 wt % web DMAc Solution+Al₂O₃ inorganic particles 20 wt %+PVDF 22 wt % Film (Acetone:DMAc=2:8)

In the case of Example 5, a two-layer structure of a separator was fabricated, in which all conditions were applied in the same manner as in Example 3, except that inorganic particles of Al₂O₃ of 20 nm in size were added in a spinning solution by 20 wt % with respect to the whole mixture including mixed polymers of PAN and PVDF and inorganic particles when the first porous polymer web layer was formed in Example 3. Characteristics of the discharging capacities measured according to 1C-rate and 2C-rate of a 2 Ah grade battery where the obtained separator of Example 5 was applied were shown in FIGS. 14 and 15, respectively.

In addition, characteristics of the discharging capacities measured according to 1C-rate and 2C-rate of 2 Ah grade batteries where the obtained separators of Comparative Examples 5 and 6 were applied were shown in FIGS. 14 and 15, respectively.

Referring to FIGS. 14 and 15, Examples 3 and 4 without addition of inorganic particles exhibited discharging capacity characteristics similar to Comparative Example 6 and Example 5 with addition of inorganic particles exhibited the best discharging capacity characteristics.

<Comparison of Heat-Resistance Characteristics According to Sizes of Inorganic Particles>

### Example 6

In order to manufacture a separator made of heat-resistant nano-fibers by an air-electrospinning (AES) method, polyacrylonitrile (PAN) of 6.6 g and polyvinylidene fluoride (PVDF) of 4.4 g were added to dimethylacetamide (DMAc) of 89 g serving as a solvent, and stirred at 80° C., to thus have prepared a mixed spinning solution made of a heat-resistant polymer and a swellable polymer. Then, inorganic particles of Al₂O₃ of 20 nm in size were added in a prepared spinning solution by 20 wt % with respect to the whole solid mixture.

The spinning solution consists of different phases from each other with respect to the heat-resistant polymer and the swellable polymer. Accordingly, phase separation may occur rapidly. Therefore, the spinning solution was put into a mixing tank and stirred using a pneumatic motor to then discharge a polymer solution at 17.5 μl/min/hole. Here, temperature of the spinning section was maintained at 33° C. and humidity thereof was maintained to 60%, while applying a voltage of 100 KV to a spin nozzle pack using a high voltage generator and at the same time an air pressure of 0.25 MPa to the spin nozzle pack, to thus have formed a porous polymer web layer made of ultrafine nano-fibers with a mixture of PAN and PVDF mixed with the inorganic particles of Al₂O₃.

Then, the obtained one-layer structure of the porous polymer web layer was moved to calender equipment. Calendering was performed using a heating/pressurizing roll, and then, in order to remove the solvent and moisture that may remain, the porous polymer web layer was made to pass through a hot-air dryer at a temperature of 100° C. and with a wind speed of 20 m/sec, to thus have obtained the separator of 20 μm thick.

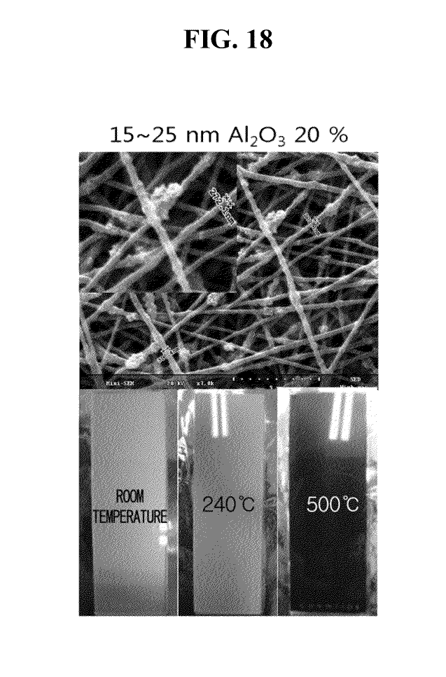

A SEM photo of the obtained separator of Example 6, and comparative photos for confirming whether or not the separator was shrunken after having undergone the heat-resistant test at the room temperature, 240° C., and 500° C., respectively, were illustrated in FIG. 18.

In addition, the shrinkage rate, the tensile strength, and the spinning stability of the spinning solution, due to the heat resistant test of the separator, were investigated and then represented in Table 2.

### Comparative Example 7

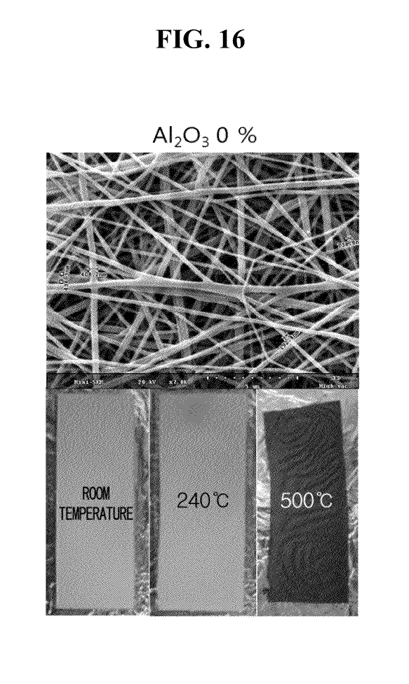

In the case of Comparative Example 7, a one-layer structure of a separator was fabricated, in which all conditions were applied in the same manner as in Example 6, except that inorganic particles were not added in a spinning solution when the porous polymer web layer was formed in Example 6. A SEM photo of the obtained separator of Comparative Example 7, and comparative photos for confirming whether or not the separator was shrunken after having undergone the heat-resistant test at the room temperature, 240° C., and 500° C., respectively, were illustrated in FIG. 16. In addition, the shrinkage rate, the tensile strength, and the spinning stability of the spinning solution, due to the heat resistant test of the separator of Comparative Example 7, were investigated and then represented in Table 2.

### Comparative Example 8

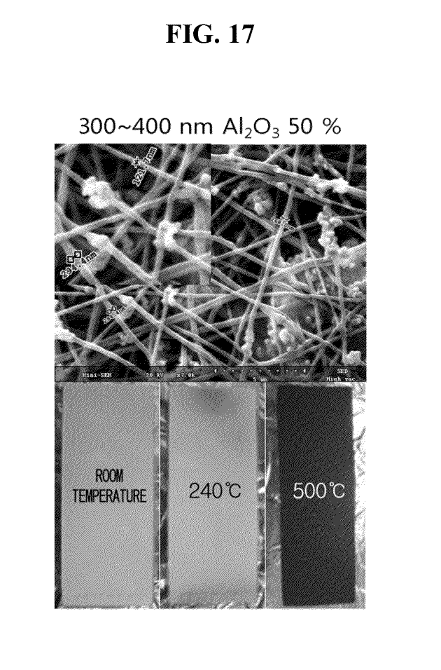

In the case of Comparative Example 8, a one-layer structure of a separator was fabricated, in which all conditions were applied in the same manner as in Example 6, except for having added inorganic particles of Al₂O₃ of 20 nm in size in a spinning solution by 50 wt %, with respect to the whole solid mixture of the spinning solution, instead of having added inorganic particles of Al₂O₃ of 20 nm in size in the spinning solution by 20 wt %, when the porous polymer web layer was formed in Example 6. A SEM photo of the obtained separator of Comparative Example 8, and comparative photos for confirming whether or not the separator was shrunken after having undergone the heat-resistant test at the room temperature, 240° C., and 500° C., respectively, were illustrated in FIG. 17. In addition, the shrinkage rate, the tensile strength, and the spinning stability of the spinning solution, due to the heat resistant test of the separator of Comparative Example 8, were investigated and then represented in Table 2.

TABLE 2

| | Comparative | Comparative | |
|---|---|---|---|
| | Example 7 | Example 8 | Example 6 |
| | Al₂O₃ | 350 nm Al₂O₃ | 20 nm Al₂O₃ |
| | 0 wt % | 50 wt % | 20 wt % |
| Shrinkage rate (MD | 20.68 | 8 | 2 |
| direction) | | | |
| Tensile strength | 169.27 | 80.11 | 88.71 |
| (MD direction: | | | |
| kgf/cm²) | | | |
| Spinning stability | Very good | Good | Good |

Referring to FIGS. 16 to 18, in the case of the separator of Comparative Example 8 doped with inorganic particles of Al₂O₃ of 350 nm, it can be seen that a lot of the inorganic particles made a lump on the outside of the nano-fibers. In the case of the separator of Example 6 doped with inorganic particles of Al₂O₃ of 20 nm, it can be seen that most of the inorganic particles were buried into the inside of the nano-fibers and part thereof were exposed from the outside of the nano-fibers.

In Example 6, the morphological changes did not occur after having undergone the heat-resistant test at 240° C. and 500° C., but in Comparative Examples 7 and 8, the shrinkage occurred severely after having had the heat resistant test at 500° C.

<Experiment of Heat Resistance Properties According to Content of Inorganic Particles>

### Examples 6 to 8, and Comparative Examples 7, 9 and 10

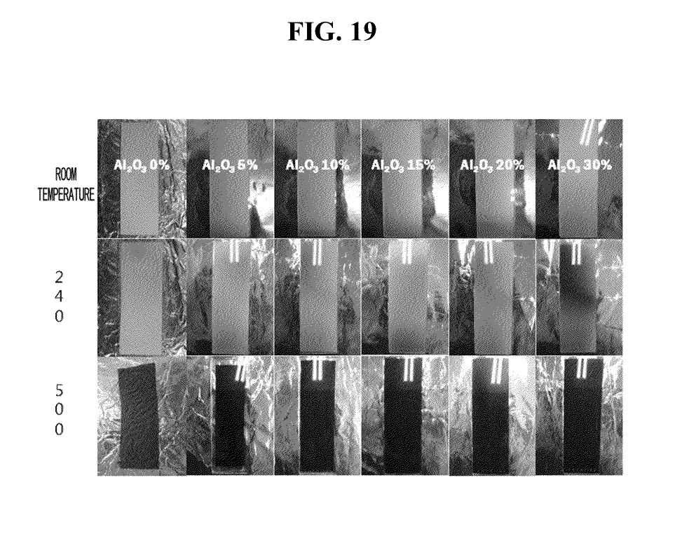

As represented in Table 3, in the case of Examples 6 to 8, and Comparative Examples 7, 9 and 10, a one-layer structure of a separator was fabricated, respectively, in which all conditions were applied in the same manner as in Example 6, except that a content of inorganic particles of Al₂O₃ of 20 nm in size was added in a spinning solution by 0 wt %, 5 wt %, 10 wt %, 20 wt %, or 30 wt % with respect to the whole mixture including mixed polymers of PAN and PVDF and inorganic particles. SEM photos of the obtained separators, and comparative photos for confirming whether or not the separator was shrunken after having undergone the heat-resistant test at the room temperature, 240° C., and 500° C., respectively, were illustrated in FIG. 19. In addition, the shrinkage rate, the tensile strength, and the spinning stability of the spinning solution, due to the heat resistant test of the separators, were investigated and then represented in Table 3.

TABLE 3

| | | Tensile strength | |
|---|---|---|---|
| | Shrinkage rate | (MD direction: | |
| | (MD direction) | kgf/cm²) | Spinning stability |
| Comparative | 20.68 | 169.27 | Very good |
| Example 7 | | | |
| (0 wt %) | | | |
| Comparative | 12.59 | 166.21 | Very good |
| Example 9 | | | |
| (5 wt %) | | | |
| Example 7 | 5.33 | 110.13 | Good |
| (10 wt %) | | | |
| Example 8 | 2.67 | 91.77 | Good |
| (15 wt %) | | | |
| Example 6 | 2 | 88.71 | Good |
| (20 wt %) | | | |
| Comparative | 1 | 67.21 | Unstable |
| Example 10 | | | |
| (30 wt %) | | | |

Referring to Table 3, when a content of inorganic particles added to the spinning solution was 5 wt % (Comparative Example 9), it was difficult to maintain the form of the film, because the shrinkage rate was relatively large as 12.59 during having undergone the heat resistant test at 500° C., and when a content of inorganic particles added to the spinning solution was 30 wt % (Comparative Example 10), the shrinkage rate was low but a problem that the spinning became unstable occurred. In contrast, if a content of inorganic particles is between 10 wt % and 20 wt % (Examples 6 to 8), the shrinkage rate was low as 2 to 5.33 when the heat resistant test was undergone at 500° C., and the spinning stability was good. The separator having the most desirable characteristics appeared in Example 8 when considering the shrinkage rate and the tensile strength.

<Probe Experiment at High Temperature>

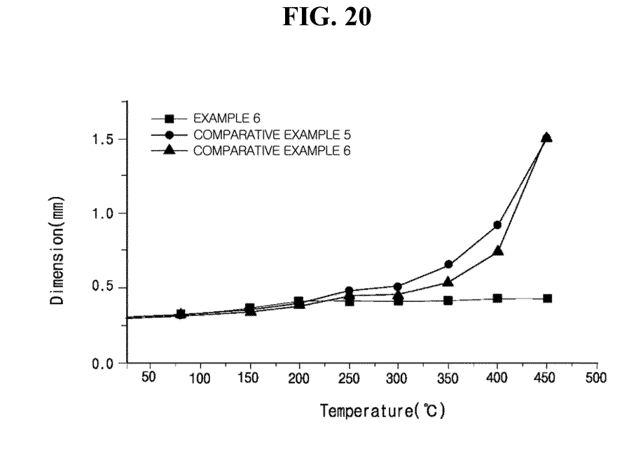

A hot tip test was carried out at between the room temperature and 450° C., using a tip of 0.2 mm in size, for separators of Example 6, and Comparative Examples 5 and 6, and the hot tip test results were shown in a graph of FIG. 20. For the hot tip test, a separator to be tested was mounted on the upper surface of a negative electrode, in which a rubber sheet and the negative electrode were mounted on a glass substrate, and a hot tip was made to pass through the separator.

In Example 6 of the present invention, as the tip temperature increased to 200° C., the diameter of the through-hole increased to approximately 0.4 mm. Thereafter, although the tip temperature increased to 450° C. or above, there were no changes in the diameter of the through-hole, but in the case of Comparisons Examples 5 and 6, as the tip temperature increased, the diameter of the through-hole increased to 1.5 mm or more.

Therefore, in the case of the heat resistant separator of the present invention, although lithium-ions moved rapidly through pin-holes and thus the instantaneous temperature rose to 400° C. to 500° C., it showed that a heat diffusion phenomenon was suppressed because the separator was a web made of nano-fibers. In addition, it showed that the separator had excellent thermal stability by addition of inorganic matters of Al₂O₃ in the heat-resistant polymer and nano-fibers.

<Direct Spinning Two-Layer Structure of Separator to Positive Electrode>

### Example 9

### PAN/PVDF (6/4) 11 wt % web DMAc Solution+PVDF 22 wt % Film (Acetone:DMAc=2:8)

In order to manufacture a separator made of heat-resistant nano-fibers by an air-electrospinning (AES) method, polyacrylonitrile (PAN) of 6.6 g and polyvinylidene fluoride (PVDF) of 4.4 g were added to dimethylacetamide (DMAc) of 89 g serving as a solvent, and stirred at 80° C., to thus have prepared a mixed spinning solution made of a heat-resistant polymer and a swellable polymer.

The spinning solution consists of different phases from each other with respect to the heat-resistant polymer and the swellable polymer. Accordingly, phase separation may occur rapidly. Therefore, the spinning solution was put into a mixing tank and stirred using a pneumatic motor to then discharge a polymer solution at 17.5 μl/min/hole. Here, temperature of the spinning section was maintained at 33° C. and humidity thereof was maintained to 60%, while applying a voltage of 100 KV to a spin nozzle pack using a high voltage generator and at the same time an air pressure of 0.25 MPa to the spin nozzle pack, to thus have formed a first porous polymer web layer made of ultrafine nano-fibers with a mixture of PAN and PVDF.

Subsequently, a second porous polymer web layer was continuously formed to the first porous polymer web layer. In other words, polyvinylidene fluoride (PVDF) of 22 g were added to a solvent of a mixture of dimethylacetamide (DMAc) of 62.4 g and acetone of 15.6 g, and stirred at 80° C., to thus have prepared a spinning solution. Then, the spinning solution was put into the mixing tank to then discharge a polymer solution by 22.5 μl/min/hole. Here, temperature and humidity of the spinning section were the same as those of the spinning section of making the first porous polymer web layer. While applying a voltage of 100 KV to a spin nozzle pack using another high voltage generator and at the same time applying an air pressure of 0.2 MPa to the spin nozzle pack, a second porous polymer web layer was formed.

The two-layer structure of the first and second porous polymer web layers with different melting points underwent a subsequent heat treatment of passing through 120° C. infrared (IR) lamp, and thus the second porous polymer web layer made of PVDF was transformed into a non-porous film phase.

Then, the first and second porous polymer web layers were continuously formed on the opposite surface of the positive electrode, and the second porous polymer web layer was transformed into a non-porous film phase.

Thereafter, the positive electrode was moved to calender equipment in which the two-layer structure of the first porous polymer web layer and the non-porous polymer film layer were formed on both surfaces of the positive electrode. Calendering was performed using a heating/pressurizing roll, and then, in order to remove the solvent and moisture that may remain, the first porous polymer web layer and the non-porous polymer film layer were made to pass through a hot-air dryer at a temperature of 100° C. and with a wind speed of 20 m/sec.

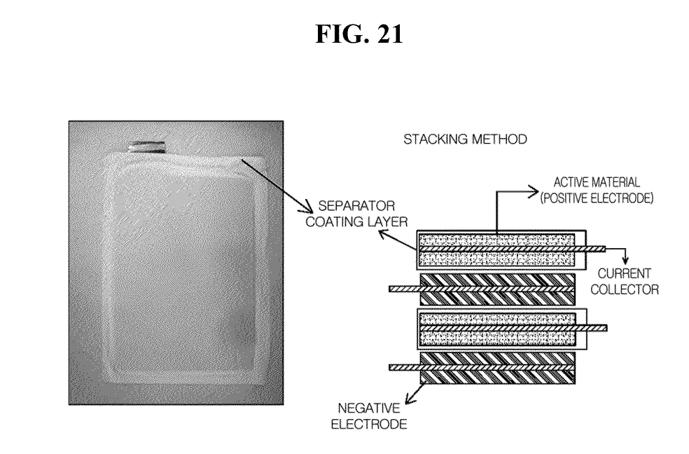

As shown in FIG. 21, in the case of the final product obtained by passing through the hot-air dryer, the polymer nano-fibers were directly spinned on both surfaces of the positive electrode, and thus the two-layer structure of the separator was coated in a sealed form. The one surface of the separator was 20 μm thick in which thickness of the first porous polymer web layer was 13 μm and thickness of the non-porous film layer was 7 μm, and both surfaces thereof were formed into 40 μm thick in total.

Thus, by using Example 6, a number of positive electrodes were alternately stacked over a number of negative electrodes in which separators were sealed on both surfaces of the positive electrode, in a sealed form, to thereby easily make a large-capacity secondary battery.

<Electrolyte Absorption Rate>

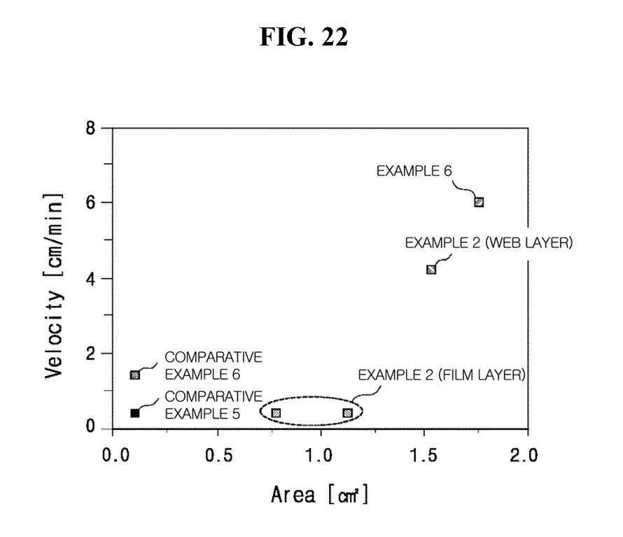

When electrolyte solutions were respectively impregnated into a separator of a two-layer structure consisting of a first porous polymer web layer and a non-porous polymer film layer according to Example 2, and a separator of consisting of a non-porous polymer film layer, a first porous polymer web layer, and an inorganic matter containing porous polymer web layer according to Example 6, an impregnation area and an absorption rate were measured and then illustrated in FIG. 22.

In addition, electrolyte solutions were respectively impregnated into a separator of Comparative Example 5 (that is, a 3-layer structure of a separator such as PP/PE/PP of Cellgard LLC) and a separator of Comparative Example 6 (that is, a separator that is obtained by ceramic coating the separator of Comparative Example 5), in the same manner as those of the above-described Examples 2 and 6, and then an impregnation area and an absorption rate were measured and then illustrated in FIG. 22.

As shown in FIG. 22, the absorption rate of the electrolyte solution was 4 cm/min in the case of Example 2 (that is, the first porous polymer web layer), and was 6 cm/min in the case of Example 6 (that is, the inorganic matter containing porous polymer web layer). The absorption rates of the electrolyte solution in Examples 2 and 6 were much speedier than about 0.4 cm/min of Comparative Example 5 and 1.5 cm/min of Comparative Example 6, and also impregnation areas of the former were wider than those of the latter.

In addition, the amount of absorbed electrolyte was 4 μLcm² in Comparative Example 5, 8 μLcm² in Comparative Example 6, and 11 μLcm² in Example 2. In the case of Example 6 in which inorganic particles were impregnated inside fibers, a pass route of lithium ions of Example 6 became shorter than that of Example 2, and thus the amount of absorbed electrolyte of the former further increased than that of the latter.

As described above, the present invention has been described with respect to particularly preferred embodiments. However, the present invention is not limited to the above embodiments, and it is possible for one who has an ordinary skill in the art to make various modifications and variations, without departing off the spirit of the present invention. Thus, the protective scope of the present invention is not defined within the detailed description thereof but is defined by the claims to be described later and the technical spirit of the present invention.

The present invention can be applied to secondary batteries of various portable electronic devices, as well as lithium-ion secondary batteries, lithium-ion polymer batteries, secondary batteries that contain supercapacitors, and separators that are used for the above-described batteries, requiring high heat resistance and thermal stability such as hybrid electric vehicles, electric vehicles and fuel cell vehicles.

What is claimed is:

1. An electrode assembly comprising:
a positive electrode;
a negative electrode; and
a separator that separates the positive electrode and the negative electrode,
wherein the separator comprises:
a first non-porous polymer film layer; and
a porous polymer web layer that is formed on the first non-porous polymer film layer and is made of ultrafine fibers of a mixture of a heat-resistant polymer and inorganic particles or a mixture of a heat-resistant polymer, a swellable polymer, and inorganic particles.

2. The electrode assembly according to claim 1, wherein the separator is formed on one or both surfaces of the positive electrode or the negative electrode.

3. The electrode assembly according to claim 1, further comprising a second non-porous polymer film layer that is formed to cover the negative electrode.

4. The electrode assembly according to claim 1, wherein the first non-porous polymer film layer is made of a polymer that is swellable in an electrolyte solution and allows conduction of electrolyte ions.

5. The electrode assembly according to claim 4, wherein the polymer is any one of PVDF (PolyVinyliDene Fluoride), PEO (PolyEthylene Oxide), PMMA (PolyMethylMethAcrylate), and TPU (Thermoplastic PolyUrethane).

6. The electrode assembly according to claim 1, wherein a content of the inorganic particles is in a range of 10 to 25 wt % for the whole mixture, and a size of the inorganic particles is set in a range of 10 and 100 nm.

7. The electrode assembly according to claim 6, wherein the size of the inorganic particles is set in a range of 15 to 25 nm.

8. The electrode assembly according to claim 1, wherein a thickness of the first non-porous polymer film layer is set in a range of 5 to 14 μm.

9. The electrode assembly according to claim 1, wherein in the case of the mixture of the heat-resistant polymer, the swellable polymer, and the inorganic particles, the heat-resistant polymer and the swellable polymer are mixed at a weight ratio in a range of 5:5 to 7:3.

10. The electrode assembly according to claim 1, wherein the electrode assembly is formed by stacking a number of the positive electrodes surrounded in a sealed state by the separator and a number of the negative electrodes that are respectively inserted between the number of the positive electrodes.

11. A secondary battery comprising:
a positive electrode;
a negative electrode;
a separator that separates the positive electrode and the negative electrode; and
an electrolyte solution,
wherein the separator comprises:
a first non-porous polymer film layer that is swellable in the electrolyte solution and that allows conduction of electrolyte ions; and
a porous polymer web layer that is formed on the first non-porous polymer film layer and is made of ultrafine fibers of a mixture of a heat-resistant polymer and inorganic particles or a mixture of a heat-resistant polymer, a swellable polymer, and inorganic particles.

12. The secondary battery according to claim 11, wherein the separator is formed on one or both surfaces of the positive electrode or the negative electrode.

13. The secondary battery according to claim 12, wherein the separator surrounds both surfaces of any one of the positive electrode and the negative electrode in a sealed state.

14. A method of manufacturing an electrode assembly, the method comprising the steps of:
preparing a positive electrode having a positive electrode active material layer formed on at least one surface of a positive electrode current collector, and a negative electrode having a negative electrode active material layer formed on at least one surface of a negative electrode current collector, respectively;
forming a separator a porous polymer web layer and a first non-porous polymer film layer, to cover one of the positive electrode and the negative electrode; and
opposing and crimping to assemble the positive electrode and the negative electrode.

15. The method of claim 14, wherein the forming of the first non-porous polymer film layer comprises:
dissolving a polymer that is swellable in an electrolyte solution and allows conduction of electrolyte ions, in a solvent, to thus form a spinning solution;
electrospinning the spinning solution on the positive electrode active material layer or the negative electrode active material layer, to thus form an ultrafine fibrous porous polymer web; and
heat-treating or calendering the porous polymer web to then be transformed into a non-porous film layer.

16. The method of claim 14, wherein the forming of the porous polymer web layer comprises:
dissolving a mixture of a heat-resistant polymer and inorganic particles or a mixture of a heat-resistant polymer, a swellable polymer, and inorganic particles, in a solvent, to thus form a spinning solution;
electrospinning the spinning solution to form an ultrafine fibrous porous polymer web; and
calendering the porous polymer web.

17. The method of claim 16, wherein a content of the polymer mixture for the spinning solution is set in a range of 10 to 13 wt %.

18. The method of claim 14, wherein the forming of the separator comprises:
dissolving a mixture of a heat-resistant polymer and inorganic particles or a mixture of a heat-resistant polymer, a swellable polymer, and inorganic particles, in a solvent, to thus form a first spinning solution;
dissolving a polymer that is swellable in an electrolyte solution and that allows conduction of electrolyte ions, in a solvent, to thus form a second spinning solution;
electrospinning the first and second spinning solutions on the positive electrode active material layer or the negative electrode active material layer, to thus form first and second ultrafine fibrous porous polymer web layers that are stacked in two layers;
heat-treating the second porous polymer web layer to thus be transformed into the first non-porous polymer film layer; and
calandering the first porous polymer web layer and the first non-porous polymer film layer that have been stacked over each other.

19. A method of manufacturing a secondary battery, the method comprises the steps of:
preparing a positive electrode having a positive electrode active material layer formed on at least one surface of a positive electrode current collector, and a negative electrode having a negative electrode active material layer formed on at least one surface of a negative electrode current collector, respectively;
electrospinning a mixture of a heat-resistant polymer and inorganic particles or a mixture of a heat-resistant polymer, a swellable polymer, and inorganic particles, to cover the positive electrode active material layer, to thus form a first porous polymer web layer that is made of ultrafine fibers;
electrospinning the swellable polymer on the first porous polymer web layer, to thus form a second porous polymer web layer that is made of ultrafine fibers, and then heat-treating the second porous polymer web layer to thus be transformed into the first non-porous polymer film layer; and
opposing and crimping to assemble the positive electrode and the negative electrode, to then be put into a case and impregnated into an electrolyte solution.

20. The method of claim 19, wherein the first non-porous polymer film layer is made of PVDF (PolyVinyliDene Fluoride), and the porous polymer web layer comprises PAN (PolyAcryl Nitrile) and PVDF (PolyVinyliDene Fluoride).
